(19) United States
(12) Patent Application Publication
(10) Pub. No.: US 2004/0103040 A1
(43) Pub. Date: May 27, 2004

(54) System, method and computer program product for a law community service system

(76) Inventors: Mostafa Ronaghi, Palo Alto, CA (US); Cameron H. Tousi, North Bethesda, MD (US)

Correspondence Address: ARENT FOX KINTNER PLOTKIN & KAHN, PLLC, SUITE 400, 1050 CONNECTICUT AVENUE, N.W., WASHINGTON, DC, 20036-5339, US

(21) Appl. No.: 10/305,393

(22) Filed: Nov. 27, 2002

(51) Int. Cl. G06F 17/60

(52) U.S. Cl. 705/26

(57) ABSTRACT

A system, method and computer program product for an online web-based law community for information sharing, collaboration and vending of services between attorneys and clients. Applications servers (ASs) and database servers (DSs) are provided for the features and functions of permitting clients to investigate attorneys by set factors (including region, jurisdiction, legal practice area, community and external reputation) and permitting attorneys to investigate clients by set factors (including region, industry, payment practices, community and external reputation). The AS/DSs also facilitate client provisioning of legal tasks, engagement of attorneys by clients, online communications between parties (through real-time chats, video, message threads), providing of standard or alternative billing, banking of payments between parties, and management of the progression of work performance and deliverables.

### BACKGROUND OF THE INVENTION

Portions of the disclosure of this patent document may contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF THE INVENTION

The present invention relates generally to the field of online services, and more particularly, to a system and method for information sharing, collaboration and vending of services between attorneys and clients in an online environment.

### RELATED ART

The relationship between an attorney and a client is a unique and special relationship, derived from both a business association between a service provider and service receiver, as well as a fiduciary association between a professional and his or her client. At its best, the relationship is a partnership characterized by unparalleled rewards of trust and financial opportunity, but at its worst, few relationships are as baffling and regretful.

Clients know their own businesses quite well, but all too often have little understanding of the field and practice of law, including what constitutes competitive or at least acceptable billing rates, superior or at least tolerable rendering of legal services, and timely delivery of tasks and deliverables. Mired in tradition, often over substance, prone to professional jargon, and retrospective in their outlook and administration of duties, versus prospective as are most businesses, legal practitioners, professional organizations and societies have not had success in correcting the problem. On the other side of the coin, legal professionals who are an extremely hard working and diligent lot, believe client expectations relating to tasks and deliverables are excessive and unrealistic. Quite often, the problem is a lack of understanding between the differing roles of the client and business owner, a communications barrier between expectations and deliverables, and the lack of opportunity for a client to know in an objective, deterministic fashion whether the legal services rendered are cost-competitive and of high quality.

Yet, both clients and attorneys recognize that good legal services are a key to the success of any business. For example, for any startup company to “start up,” at the very least the legal entity must be formed, shares must be distributed between founders, intellectual property must be protected, and quality board members and working professionals must be incentivized through options and warrants.

For many years, larger companies who can afford to do so have employed in-house counsel not only to manage expensive “outside” lawyers and firms, but in some ways to replace them by (i) splitting with and sometimes taking over duties traditionally handled by outside lawyers, (ii) handling a number of activities in-house, including contract negotiations, employee contracts, mediation, licensing, and litigation; (iii) providing a competitive leverage to encourage outside lawyers to work more leanly; and (iv) anticipating legal risks in an objective manner to prevent problems from escalating. Unfortunately, hiring of an in-house attorney is cost prohibitive for individuals, business proprietors, and even technology startup companies, until certain threshold revenue streams are achieved.

Selection of the proper attorney can be daunting and intimidating. With little access or knowledge of what skills constitute superior legal counseling, the prior experience and reputation of a given attorney in their field of expertise, whether an attorney is worth their billing rate, and how one goes about fostering healthy competition between competing attorneys, clients often have to base decisions on word-of-mouth. A client will often choose a lawyer because of their firm, reasoning that a quality firm will hire skilled, experienced attorneys with good educational backgrounds.

Managing and evaluating the work of attorneys is likewise not a simple matter for clients. Accessing the legal work requires an understanding of strategy, quality, staffing and tactics, which does not come without previous experience. Accessing legal expenses requires an understanding of cost-to-quality dynamics for a given field of law, knowledge of competitive rates for a geographical area, and attorney experience level. There is also an interplay between legal work and expenses, as the management of the two cannot be separated without adversely affecting the quality of counseling, tasks, and deliverables and the business' realistic legal budget.

What is needed is a solution to the problem that (i) provides clients a better understanding of time, effort and quality of legal counseling, tasks and deliverables, the time required to fulfill them, and what constitutes competitive pricing; (ii) makes it easier and more enjoyable for clients to find the best attorney for their needs and share insights on performance with others; (iii) makes it easier to manage the progression of tasks and deliverables, as well as providing cost-justification for work performed; (iv) provides more effective, easier to implement communication between clients and attorneys, as well as clients and other clients, and attorneys and other attorneys; and (v) provides clients trustworthy and objective information they will not believe is biased by attorney profit incentives.

### SUMMARY OF THE INVENTION

In an exemplary embodiment of the present invention a system, method and computer program product for a community service system is disclosed.

The present invention includes system, method and computer program product implementations that can be used in a node-node environment, a machine instructions environment, a computer hardware environment, a client-server environment, and Internet and World Wide Web environment.

The community service system provides an online community service system for performing transactions between user entities using the system. In a number of embodiments, the user entities are respectively service provider user entities and service recipient user entities, and the transactions include information sharing, investigations, collaboration and vending of services.

In a number of embodiments, the online community service system is a web-based law community service system, where the service provider user entities are law firm and attorney user entities, and the service recipient user entities are client user entities. In a number of embodiments, the online transactions include (i) registration of user entities, (ii) investigation of attorneys, (iii) investigation of clients, (iv) client tasks, (v) engagement conditions, (vi) online communication, (vii) billing methods, (viii) banking, and (ix) progress management.

In exemplary embodiments, application programs and accompanying databases, in the form of applications servers (ASs) and database servers (DSs) are used to implement the law community service system transactions, although any of aforementioned environments may be used.

The registration of user entities embodiment includes maintaining and updating the contents for a Homepage, extracting personal and professional information from client, attorney and firm user entities, and having the user entities agree to the law community service system conditions.

The investigation of attorneys embodiment includes soliciting personal and professional information from attorney and law firm user entities for the benefit of client user entities.

The investigation of clients embodiment includes soliciting personal and professional information from client user entities for the benefit of attorney and law firm user entities.

The client tasks embodiment includes soliciting criteria related to legal work from client user entities and providing the criteria to attorney and law firm user entities.

The engagement conditions embodiment includes online evaluation and agreement to engagement conditions between client user entities and attorney or law firm user entities.

The online communication embodiment includes providing online communication for user entities so that user entities can communicate with one another and retrieve information, including through real-time chats, video, radio and message threads.

The billing methods embodiment includes permitting client user entities and attorney or law firm entities the ability to investigate and agree to standard billing arrangements, alternative billing arrangements, or auction billing arrangements.

The banking embodiment includes permitting the user entities the ability to bill one another and pay for services rendered using the law community service system, and the ability for third parties, including the law community service system, to receive payments as well.

The progress management embodiment includes permitting client user entities to determine and manage the legal work, billing amounts provided by attorney and law firm user entities, and to evaluate their level of satisfaction with the performance of the attorney and law firm user entities.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 illustrates an exemplary computer and telecommunications network environment;

FIG. 2 illustrates an exemplary computer system environment;

FIG. 3 illustrates an exemplary client-server environment;

FIG. 4 illustrates a detailed exemplary client-server environment;

FIG. 5 illustrates en exemplary modular structure for application servers and database servers used in implementing the presenting invention;

FIGS. 6A, 6B and 6C illustrate the exemplary first, second and third portions of a web page for registration of attorneys and law firms stored, maintained, uploaded/downloaded, and processed on the Law Community service system;

FIG. 6D illustrates en exemplary manner in which a client's review of a user agreement and a privacy agreement can be verified online;

FIG. 6E illustrates an exemplary manner in which a client can provide billing information upon online registration;

FIG. 6F illustrates an exemplary attorney index and numerous exemplary fields for attorney user entities;

FIG. 6G illustrates an exemplary law firm index and numerous exemplary fields for law firm user entities;

FIG. 6H illustrates an exemplary legal practice area index and numerous exemplary fields for legal practice areas;

FIG. 6I illustrates an exemplary firm size index and numerous exemplary fields for firm sizes;

FIG. 6J illustrates an exemplary lawyer registration index and numerous exemplary fields for lawyer jurisdictions;

FIG. 6K illustrates an exemplary ethics index and numerous exemplary fields relating to lawyer ethics guidelines;

FIG. 7A illustrates an exemplary map of the United States territories that that may be illustrated to a client user entity;

FIG. 7B illustrates an exemplary list of the most populated legal practice areas provided to a client user entity;

FIG. 7C illustrates an exemplary list of law groups having their own legal practice areas provided to a client user entity;

FIG. 7D illustrates an exemplary manner in which comparable information regarding attorneys can be can be provided to a client user entity;

FIG. 8 illustrates such an exemplary industry area database for client user entities, which can be illustrated to an attorney user entity;

FIGS. 9A and 9B illustrates exemplary manners in which legal work for a client user entity can be provided online;

FIG. 10 illustrates an exemplary manner in which a client user entity and an attorney user entity can negotiate the terms of a client engagement agreement;

FIG. 11A illustrates an exemplary online discussion thread for posting to the Law Community service system;

FIG. 11B illustrates exemplary contents of message threads posted to the Law Community service system;

FIG. 11C illustrates an exemplary online chat session for the Law Community service system;

FIG. 11D illustrates an exemplary online interface for radio and video feeds for the Law Community service system;

FIG. 12A illustrates exemplary online auctions for legal services between client user entities and attorney user entities or law firm user entities;

FIGS. 12B, 12C and 12D illustrate exemplary fee arrangement information available in the Law Community service system;

FIG. 13A illustrates an exemplary manner in which traditional bill presentment and payment and electronic bill presentment and payment can be employed on the system;

FIG. 13B illustrates an exemplary manner in which a consolidation and aggregation service can be used on the system; and

FIG. 14 is an exemplary conceptual diagram illustrating an object oriented or multilevel view of progress management features provided by the system.

### DETAILED DESCRIPTION OF AN EXEMPLARY EMBODIMENT OF THE PRESENT INVENTION

TABLE OF CONTENTS

| | |
|---|---|
| I. | EXEMPLARY EMBODIMENT |
| II. | NODE-NODE ENVIRONMENT |
| III. | MACHINE INSTRUCTIONS ENVIRONMENT |
| IV. | COMPUTER HARDWARE ENVIRONMENT |
| V. | CLIENT-SERVER ENVIRONMENT |
| VI. | INTERNET AND WORLD WIDE WEB ENVIRONMENT |
| A. | Introduction 18 |
| B. | Displaying Information and Navigating on the Web |
| VII. | LAW COMMUNITY |
| A. | Introduction |
| B. | Registration |
| C. | Investigations of Attorneys |
| D. | Investigations of Clients |
| E. | Client Task |
| F. | Engagement Conditions |
| G. | On-Line Communication |
| H. | Billing Method |
| I. | Banking |
| J. | Progress Management |
| VIII. | CONCLUSION |

I. Exemplary Embodiment

While specific exemplary examples, environments and embodiments are discussed below, it should be understood that this is done for illustration purposes only. A person skilled in the relevant art will recognize that other components and configurations can be used without parting from the spirit and scope of the invention. In fact, after reading the following description, it will become apparent to a person skilled in the relevant art how to implement the invention in alternative examples, environments and embodiments.

II. Node-Node Environment

In one or more embodiments, the invention is practiced in the environment of a computer network or networks. The network can include a private network, or a public network (for example the Internet, as described below), or a combination of both. The network includes hardware, software, or a combination of both.

As skilled persons will recognize, from a high-level, telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. Skilled persons will recognize that the distinction between hardware and software is not always easily defined, with the same or similar functions capable of being preformed with use of either. This is especially true for functionality associated with the communications between processes.

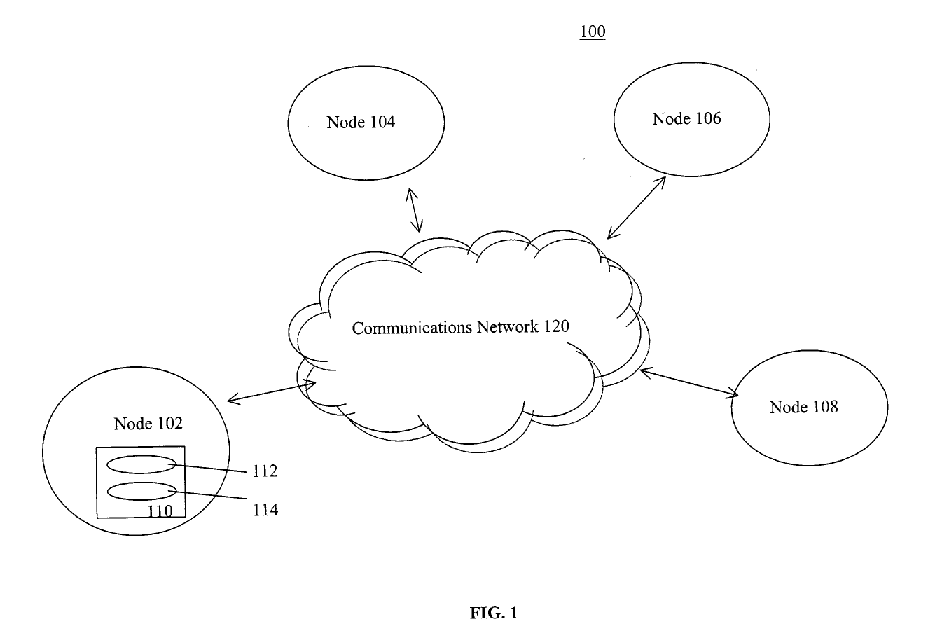

FIG. 1 illustrates an exemplary computer and telecommunications network environment 100. Environment 100 includes nodes 102-108, which include hardware, software, or a combination of hardware and software. Nodes 102-108 are interconnected via communications network 120. Each node 102-108 includes one or more processes 112, 114, executable by processors 110 incorporated into the nodes. It is possible that a single process 112 can be run by multiple processors 110, or that multiple processes 112, 114 can be run by a single processor 110. Additionally, each of nodes 102-108 can provide an interface point between network 100 and the outside world, and can incorporate a collection of subnetworks.

Persons of skill in the art will appreciate that the “software” processes 112, 114 include software and/or hardware entities that perform work over time, such as tasks, threads, and intelligent agents. Also, each process 112 can refer to multiple processes, for carrying out instructions in sequence or in parallel, continuously or intermittently.

In one embodiment, the processes 112, 114 communicate with one another through interprocess communication pathways (not labeled) supporting communication through any communications protocol. The pathways can function in sequence or in parallel, continuously or intermittently. The pathways can use any of the communications standards, protocols or technologies, described below with respect to communications network 120, in addition to standard parallel instruction sets used by many computers.

Nodes 102-108 include any entities capable of performing processing functions. Examples of nodes 102-108 that can be used with the present invention include computers (such as personal computers, workstations, servers, or mainframes), handheld wireless devices and wireline devices (such as personal digital assistants (PDAs), modem cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between nodes 102-108 is made possible by communications network 120. A node 102-108 can be connected either continuously or intermittently with communications network 120. As an example, in the context of the present invention, communications network 108 can be a digital communications infrastructure providing adequate bandwidth and information security.

Communications network 120 can include wireline communications capability, wireless communications capability, or a combination of both, at any frequencies, using any type of standard, protocol or technology. In addition, in the present invention, communications network 120 can be a private network (for example, a VPN) or a public network (for example, the Internet).

A non-inclusive list of exemplary wireless protocols and technologies used by communications network 120 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies, as set forth in Table 1. A exemplary non-inclusive list of primarily wireline protocols and technologies used by communications network 120 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

TABLE 1

| GENERATION | DESCRIPTION |
|---|---|
| 1G | 1G refers to the first generation wide area wireless (WWAN) |
| | communications systems, dated in the 1970s and 1980s. These |
| | devices are analog, designed for voice transfer and circuit- |
| | switched, and include AMPS, NMT and TACS. |
| 2G | 2G refers to second generation WWAN communications, dated in |
| | the 1990s, characterized as digital, capable of voice and data |
| | transfer, and include HSCSD, GSM, CDMA IS-95-A and D- |
| | AMPS (TDMA/IS-136). |
| 2.5G | 2.5G refers to the generation of WWAN communications |
| | between 2G and 3 G. |
| 3G | 3G refers to third generation WWAN communications systems |
| | recently coming into existence, characterized by data rates of 144 Kbps |
| | to over 2 Mbps (high speed), being packet-switched, and |
| | permitting multimedia content, including GPRS, 1xRTT, EDGE, |
| | HDR, W-CDMA. |
| 4G | 4G refers to fourth generation WWAN communications systems, |
| | expected to come in the years 2006-2010, characterized by very |
| | high-speed (over 20 Mbps) data rates, permitting high-resolution |
| | for video. |

As noted, each node 102-108 includes one or more processes 112, 114, executable by processors 110 incorporated into the nodes. In a number of embodiments, the set of processes 112, 114, separately or individually, can represent entities in the real world, defined by the purpose for which the invention is used.

Examples of “real-life” entities that can be used with the present invention include clients, who require legal services and tasks to be performed, and attorneys, who provide such legal work and services for the clients. However, the present invention is not limited to use by clients and attorneys, and can include any individuals who wish to pay for or barter for goods or services, and other individuals who provide such goods or services. As described below, the service providers and service recipients are not limited to persons, and can include legal entities or machines.

Furthermore, the processes 112, 114 and processors 110 need not be located at the same physical locations. In other words, each processor 112, 114 can be executed at one or more geographically distant processor 110, over for example, a LAN or WAN connection.

Persons of skill in the art will appreciate a great range of possibilities for practicing the invention using different networking hardware and software configurations.

III. Machine Instructions Environment

In one or more embodiments, the steps of the present invention are embodied in machine-executable instructions. The instructions can be used to cause a processing device, for example a general-purpose or special-purpose processor, which is programmed with the instructions, to perform the steps of the present invention.

Alternatively, the steps of the present invention can be performed by specific hardware components that contain hardwired logic for performing the steps, or by any combination of programmed computer components and custom hardware components.

For example, the present invention can be provided as a computer program product. In this environment, the invention can include a machine-readable medium having instructions stored on it. The instructions can be used to program any processor (or other electronic devices) to perform a process according to the present invention.

The machine-readable medium can include, for example, floppy diskettes, optical disks, CD-ROMs, and magneto-optical disks, ROMs, RAMs, EPROMs, EEPROMs, magnet or optical cards, or other type of media/machine-readable medium suitable for storing electronic instructions, but is not limited to the foregoing.

In addition, the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

IV. Computer Hardware Environment

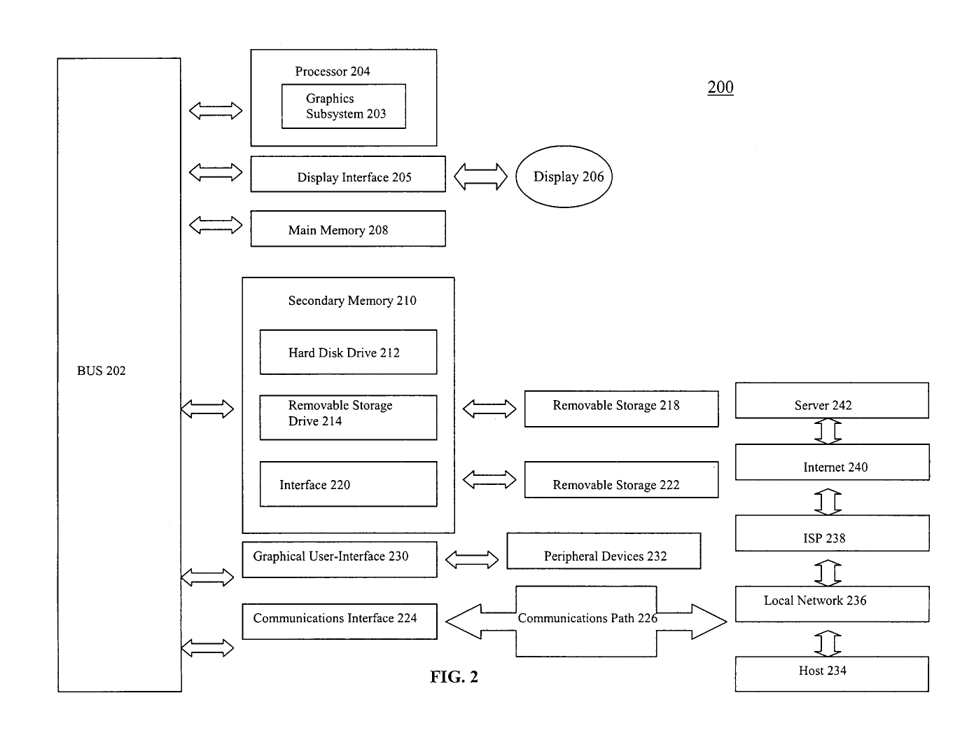

In one embodiment, illustrated in FIG. 2, node 102 is a computer system 200. Computer system 200 includes bus 202, processor 204 (including graphics subsystem 203), display interface 205, display 206, main memory 208, secondary memory 210 (including hard disk drive 212, removable storage drive 214, and interface 220), removable storage units 218, 222, graphical user-interface 230, peripheral devices 232 and communications interface 224. Computer system 200 is also connected via communications path 226 to external networks. Various embodiments are described in terms of this example computer system. After reading this description, it will be apparent to a person skilled in the relevant art how to implement the invention using other computer systems and/or computer architectures.

Processor 204, which can represent multiple processors, is connected to a communications bus 202. Graphics subsystem 203, shown as associated with processor 204, can be implemented as one or more processor chips. In fact, graphics subsystem 203 can be included as part of processor 204 as shown in FIG. 2 or as a separate graphics engine or processor. Graphics data is output from the graphics subsystem 203 to the bus 202.

Display interface 205 forwards graphics data from the bus 202 for display on the display unit 206. This graphics data includes graphics data for the screen displays described herein.

Main memory 208 can be a random access memory (RAM), and can also include a secondary memory 210. In the present invention the secondary memory 210 can include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc., which is read by and written to by removable storage drive 214. As will be appreciated, the removable storage unit 218 includes a computer usable storage medium having stored therein computer software and/or data.

In alternative embodiments, secondary memory 210 can include other similar means for allowing computer programs or other instructions to be loaded into computer system 200. Such means can include, for example, a removable storage unit 222 and an interface 220. In the present invention examples can also include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to computer system 200.

Graphical user interface module 230 transfers user inputs from peripheral devices 232 to bus 206. These peripheral devices 232 can be a mouse, keyboard, touch screen, microphone, joystick, stylus, light pen, or any other type of peripheral unit.

Computer system 200 can also include a communications interface 224. Communications interface 224 allows software and data to be transferred between computer system 200 and external devices via communications path 226. Examples of communications interface 224 that can be used with the present invention include a standard or cable modem, a DSL connection, a network interface (such as an Ethernet card), a communications port, a LAN connection, a WAN connection, etc. Computer programs and data transferred via communications interface 224 are in the form of signals which can be electronic, electromagnetic, optical or other signals capable of being received by communications interface 224, via communications path 226. Note that communications interface 224 provides a means by which computer system 200 can interface to a network such as the Internet.

The present invention can be implemented using computer programs (i.e., “software,” or “computer control logic”) running on Processor 204. The software can be originally stored as a “computer program product” on removable storage device 218 or hard disk drive 212. Therefore, computer program product refers to means for providing software to computer system 200.

Computer programs can also be stored in main memory 208 and/or secondary memory 210. Computer programs can also be received via communications interface 224. Such computer programs, when executed, enable the computer system 200 to perform the features of the present invention as discussed herein. In particular, the computer programs, when executed, enable the processor 204 to perform the features of the present invention.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant arts.

In the example environment shown, communication interface 224 provides a two-way data communication coupling via a communications path 226 to a local network 236. For example, if communication interface 224 is an integrated services digital network (ISDN) card or a modem, communication interface 224 provides a data communication connection to the corresponding type of telephone line, which comprises part of communications path 226. If communication interface 224 is a local area network (LAN) card, or connects to a LAN 236, then it can provide a data communication connection via communications path 226 to a compatible LAN. Wireless links are also possible. In any such implementation, communication interface 224 sends and receives electrical, electromagnetic or optical signals which carry digital data streams representing various types of information.

Communications path 226 typically provides data communication through one or more networks to other data devices. For example, in the present invention communications path 226 can provide a connection through local network 236 to host computer 234 or to data equipment operated by an Internet Service Provider (ISP) 238. In turn, ISP 238 provides data communication services through the worldwide packet data communication network now commonly called the “Internet” 240, described in detail in other embodiments.

Local network 236 and Internet 240 both use electrical, electromagnetic or optical signals that carry digital data streams. The signals through the various networks and the signals on communications path 226 and through communication interface 224, which carry the digital data to and from computer 200, are exemplary forms of carrier waves transporting the information.

Computer system 200 can send messages and receive data, as well as computer programs, through the network or networks, communications path 226, and communication interface 224. If the network used is the Internet, server 242 can transmit a requested code for an application program through Internet 240, ISP 238, local network 236 and communications path 226. Examples of such applications are the application programs run by application servers and database servers, as described in detail below.

V. Client-Server Environment

In one embodiment, the aforementioned nodes 102-108, processors 110, and processes 112, 114 running on the processors, are described by virtue of their functions with respect to information retrieval within a network.

Specifically, a node that requests information is termed a “client” and a node that transmits the requested information is termed a “server.” A node can have the dual roles of serving as both a client as well as a server.

The processes running on the clients are termed client applications, and the processes running on a server are termed server applications. Information exchange occurs between the server application providing the information or services, and the client application receiving the provided information and services.

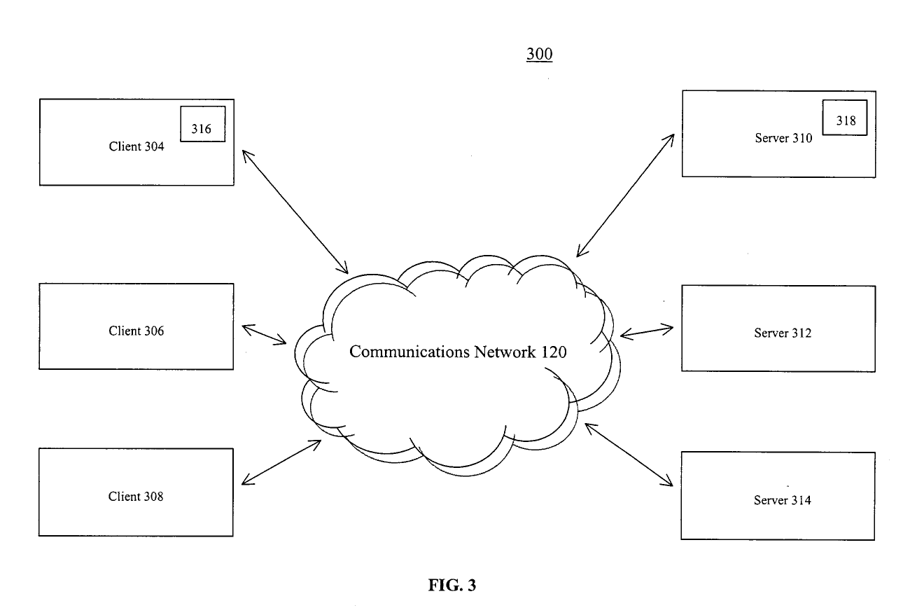

FIG. 3 illustrates an exemplary client-server environment 300. Client-server environment 300 includes the aforementioned communications network 120, which can be a national or an international network. It also includes a number of clients 304-308, and a number of servers 310-314. The clients 304-308 and the servers 310-314 are nodes connected to network 120, defined by their respective information retrieval functions.

Client 304 includes a client application 316, which is an information requesting or receiving application associated with client 304. Client application 316 either runs on client 304 or runs on another node and is passed to client 304.

Server 310 includes a server application 318, which is an information retrieval application associated with server 310. Server application 318 either runs on server 310 or runs on another node and is passed to server 310.

In operation, client application 316 is executed on client 304. In response, client 304 issues a request for information transmitted over network 120. The request is received by server 310, which executes server application 318. The requested information and/or services are then transmitted back to client 304 over network 120.

VI. Internet and World Wide Web Environment

A. Introduction

In these embodiments, an introduction of the Internet and how it is used in the context of the present invention is provided. As noted, network 120 can be any type of network, either private or public. In one or more embodiments, environment 300 (including network 120) refers to the Internet and World Wide Web (Web). In these embodiments, clients and servers transmit information in formats and media acceptable to the Internet and Web.

Internet refers to a worldwide system of interconnected computer networks that use the Transmission Control Protocol/Internet Protocol (TCP/IP) set of protocols. TCP/IP, in turn, typically refers to a bundle of network protocols, including: (i) the IP, a network layer protocol where unique IP addresses identify each network and each of its hosts, (ii) TCP, a connection-oriented protocol, where a connection is established via handshakes before any data is transmitted and (iii) certain application layer protocols, including telnet and file transfer protocol (FTP).

The parts of the Internet that are most widely used are electronic mail (e-mail) and the aforementioned Web. The Web is a network of computers located all over the world. These international computer networks can be comprised of clients and servers that users access to locate resources.

All the clients 304-308 and servers 310-314 in the Web can communicate with each other, and normally use a communication standard called Hypertext Transfer Protocol (HTTP). HTTP is an application protocol, i.e. a set of rules, for exchanging files on the Web that runs on top of TCP/IP.

The information on the Web is stored in documents called Web pages, which are files stored on the servers 310-314 comprising the Web. The clients 304-308 request the Web pages from the servers 310-314 (specifically server applications 318 running on the servers 310-314). More specifically, client applications 316 running on the clients 304-308 request the Web pages from server applications 318 running on the servers 310-314.

B. Displaying Information and Navigating on the Web

In these embodiments, the displaying of information and navigating on the Web in the context of the present invention is provided.

The client applications 316 are typically called Web browsers. Examples of well known browsers 316 that can be used with the present invention include Spry's Mosaic, Microsoft's Internet Explorer, and Netscape's Navigator. Browsers 316 are capable of understanding a variety of program languages used to design the Web pages, as well as protocols used to transmit the Web pages.

Web browsers 316 have varying levels of sophistication and functionality. Each screenful of information includes such items as highlighted words, graphics, menu choices, through which users can hyperlink (or “link”) to retrieve further information, either from the client 304-308 itself (for local files) or from servers 310-314 located on the Web. Table 2 contains common Internet terms known to skilled persons.

The manner of displaying the retrieved informational content in a web browser 316 is primarily according to formatting and display languages. Examples of formatting and display languages that can be used with the present invention include Hyper Text Markup Language (HTML), eXtensible Markup Language (XML), EXtensible HyperText Markup Language (XHTML), and Cascading Style Sheets (CSS).

HTML is used to create text files that contain markup tags, which inform the browser how to display the page. HTML files must have an “htm” or “html” file extension, and can be created using a simple text editor. XML is a markup language, permitting users to define their own markup tags. The markup tags in XML are not predefined as with HTML. XML uses a Document Type Definition (DTD) or an XML Schema to describe the data. While HTML was designed to display data, focusing on how the data appears, looks, XML was designed to describe data, focusing on the data itself, providing the ability to structure, store, and to send information. XML is pared-down version of Standard Generalized Markup Language (SGML), specifically designed for Web documents. SGML is a comprehensive system for the organization and tagging of document elements. Rather than specifying particular formatting, SGML specifies the rules for tagging elements. XHTML is the same as a version of HTML referenced as HTML 4.01. It is HTML defined as an XML application and applies a strictly defined version of HTML. CSS is used to design stylesheet pages, which define how the document is displayed or printed to the browser. CSS sheets can be attached to the HTML document itself. The cascading feature supported by CSS permits a single document to use two or more stylesheets, which are applied according to specified priorities.

The manner of formatting the information for retrieval from servers 310-314 and transmitting the retrieved information over network 120 are determined by protocols. A variety of protocols can be used to implement the present invention over the Internet, including the aforementioned HTTP, FTP, telnet, as well as, for example, Internet Relay Chat (IRC).

The main protocol (or set of rules for navigation and exchanging of files between clients and servers) used on the Web is HTTP, designed for exchanging files running on top of TCP/IP. HTTP not only defines how messages are formatted and transmitted, but also what actions Web server applications 318 and browsers 316 should take in response to various commands.

The act of using a client browser 316 to download a Web page located at a server application 318 can also be called navigating the Web, or browsing the Web, or linking to Web sites on the Web. Each Web page has a Web address called a Uniform Resource Locators (URLs). Consequently, Web pages are located by linking to the URL of a Web page and displaying it in the browser 316. Users can link to Web pages by selecting or clicking on menu choices, highlighted words, or graphics associated with URLs. When a user enters a URL in his/her browser, or otherwise attempts to link to a website, it causes an HTTP command to be sent to the appropriate Web server, directing it to fetch and transmit the requested Web page.

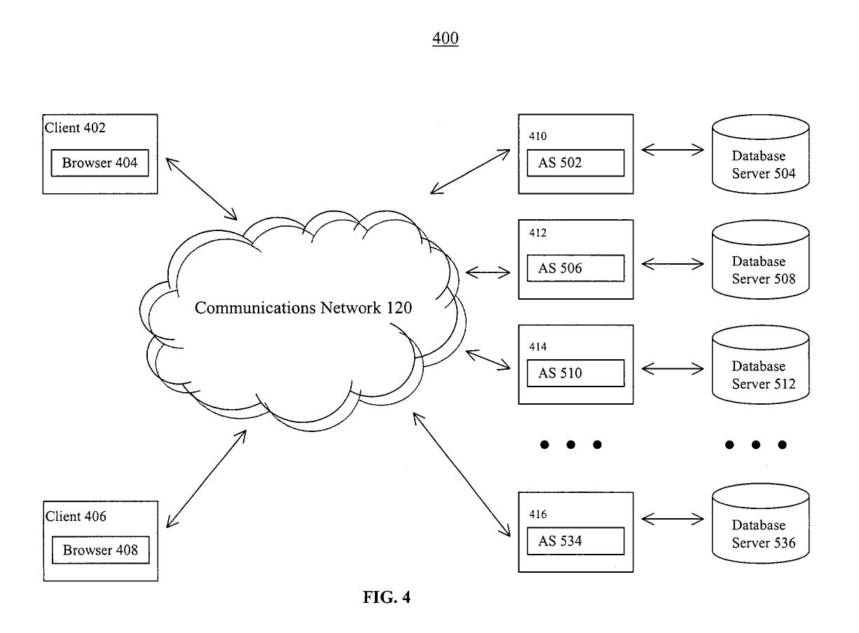

FIG. 4 illustrates a detailed exemplary client-server environment 400. Environment 400 of FIG. 4 includes the aforementioned communications network 120, a plurality of clients 402, 406 and a plurality of servers 410, 412, 414, 416, connected to network 120. The servers are shown connected to a plurality of database servers (DSs). Specifically, server 410 is connected to DS 504, server 412 is connected to DS 508, server 414 is connected to DS 512, and server 416 is connected to DS 536.

The clients 402, 406 and the servers 410-416 are nodes connected to network 120, defined by their respective information retrieval functions. Client 402 includes a client application 404, which is an information requesting or receiving application associated with client 402, and client 406 includes a client application 408, which is an information requesting or receiving application associated with client 406. Client applications 404, 408 can run either on clients 402, 406, respectively, or can run on another node and are then passed to the clients 402, 406. In one or more embodiments, the client applications 404, 408 are web browsers.

Servers 410-416 include a variety of processes, including operating systems, web server applications and application servers. The operating systems, which can also be called platforms, are the software programs that applications use to communicate with the physical parts of the servers 410-416. Examples of operating systems that can be used with the present invention include: Linux,™ Sun Solaris,™ Windows NT/2000,™ Cobalt RaQ™ and Free BSD,™ although any operating systems known or anticipated can be used.

The web server applications are software running on servers 410-416 that make it possible for the client browsers 404, 408 to download stored web pages. These applications also coordinate streaming audio, video, and secure e-commerce, and can be integrated with databases (as described below) for information retrieval. Examples of web server applications that can be used with the present invention include: Apache,™ Microsoft's Internet Information Server (IIS),™ O'Reilly & Associates WebSite Pro,™ Netscape's FastTrack Server,™ and StarNine's WebSTAR™ (for Macintosh), although any operating systems known or anticipated can be used.

The application servers sit on top of the formatting and display languages (for example, HTML) that a request from clients 402, 406 generate and translated the request for databases. Upon receiving information from databases, the application servers will translate this information back to the formatting and display languages and sent a response back to the browser. In one or more embodiments, the application server software resides at the servers 410-416, although with cross-platform programming technology, software performing the same functions can reside at clients 402, 406 as well. In one or more embodiments, the application servers will insert strings of programming code into the formatting and display language, with client browsers 404, 408 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server, Oracle Application Server™, PowerTier for C++™, PowerTier for Enterprise Java Beans™, Secant Extreme™, Enterprise Server™, SilverStream™, WebEnterprise™, WebSpeed™, and WebSphere,™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 402, 406.

The variety of processes running on servers 410-416 can be written using any program languages and types. Some or all of the programs can be cross-platform applications that additionally to running on the servers (or instead of running thereon) run on the clients 402, 404. Examples of cross-platform programs are Java applets, which run on clients, and servlets, which run on servers. Examples of programming languages that can be used with the present invention include: CGIT™, Perl™, Java™, VBScript™, Python,™ Microsoft ASP™, Java™, C++, Visual Basic, Enterprise JavaBean (EJB), although any languages known or anticipated can be used.

For the convenience of condensing terminology, the aforementioned applications working, which work together on the servers 410-416 (or instead are processed at other nodes and passed to servers 410-416) are referred to as “application servers.” FIG. 4 illustrates applications servers (ASs) 502, 506, 510, 534 respectively running on clients 410, 412, 414, 416. In operation, client browsers 404, 408 are used to issue requests for information, or queued to transmit information, over network 120. Requests and responses are handled by servers 410-416 via running of ASs 502, 506, 510, 534, which in turn transmit information over network 120 for display by browsers 404, 408.

In one or more embodiments, additional functions required of ASs 502, 506, 510, 534 will be to connect the web servers 410-416 to, for example, back-end data resources such as relational tables, flat files, e-mail messages, and directory servers. In exemplary embodiments, additional programs incorporated in ASs 502, 506, 510, 534 typically called “middleware,” database utilities, or database management systems (DMBS) can be used, among other known or anticipated database methods.

For example, the ASs 502, 506, 510, 534 can include their own internal DBMSs, or DBMSs of other nodes, or the DBMSs labeled database servers (DSs) 504, 508, 512, 536. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 402, 406, for example, or at server 502-504, for example, and returns a result to the user, for example in the form of a relational table viewable in browsers 404, 408. The DBMS can refer to any type of database, including a relational DBMS (RDBMS), LDAP,™ VSAM™, IMS™, Active Directory Services,™ message stores, to name a few.

In one or more embodiments, the DBMS is an RDBMS that uses relational database to retrieve information from the database. In one or more embodiments, the relational database uses structured query language (SQL™), including SQL defined according to International Standards Organization (ISO) and American National Standards Institute (ANSI) standards, or follow these standards with additional language constructs. In one or more exemplary embodiments, ASs 502-504 are respectively connected to DSs 504-536 via an application programming interface (API), including for example the open database connectivity (ODBC™), Java database connectivity (JDBC™), APIs.

In one or more embodiments, additional interfaces are used that can be employed for multiple types of databases, not just relational databases. One example is Microsoft's OLE-DB™ that provides access to all types of information, whether stored in RDBMS™, VSAM™, IMS™, Active Directory Services,™ message stores, among others.

Any types of DBMS platforms can be used in the present invention. Exemplary platforms employed include Sun Microsystems' Java™ 2 Platform, Enterprise Edition (J2EE),™ which contains an Enterprise JavaBeans™ (EJB) server-side component architecture, and Microsoft's Windows™ Distributed interNet Applications Architecture (Windows DNA™), which contains the COM+™ server-side component architecture.

TABLE 2

| INTERNET | |
|---|---|
| TERM | DEFINITION |
| ActiveXControl | A COM object that can be loaded from a server via inter-or intranet |
| | and run on any NT-client. |
| Browser | A Browser (or Web Browser) is a computer application that fetches |
| | Web pages from servers on the Internet and displays them on the |
| | user's local machine. |
| CML | Chemical Markup Language is an XML schema designed for |
| | handling information concerning chemical substances. |
| COM | Component Object Model is an MS-paradigm for connecting |
| | components, which has implemented the base technology for COM |
| | on the NT platform. |
| CSS | Cascading Style Sheets refers to a W3C Recommendation for files |
| | that when attached to a document will describe how the document is |
| | to be displayed or printed. |
| DHTML | Dynamic HTML is a standard for extending HTML that consists of |
| | HTML 4.0, DOM, CSS, and certain scripting languages. |
| DocBook | DocBook refers to XML and SGML DTDs and DSSSL/XSL |
| | stylesheets owned by OASIS for use in modeling manuals and |
| | converting them. |
| DocZilla | DocZilla is the Web browser offered by CITEC that can render |
| | XML, SGML, and HTML documents. |
| DTD | Document Type Definition refers to a specification for schema |
| | specification for SGML and XML documents. The DTDs can be |
| | contained within a document or belong to an external subset that is |
| | referenced. Examples of DTDs include HTML, DocBook, CML, |
| | and IBTWSH. |
| ebXML | electronic business XML, A project jointly initiated by |
| | UN/CEFACT (= The United Nations body for Trade Facilitation and |
| | Electronic Business) and OASIS to standardize XML business |
| | specifications. ebXML intends to develop a technical framework |
| | that will enable XML to be utilized in a consistent manner for the |
| | exchange of all electronic business data. |
| FTP | File Transmission Protocol refers to an application protocol for |
| | exchanging files over top of TCP/IP. FTP can be used to upload a |
| | webpage to a server. |
| HTML | Hypertext Markup Language is a DTD that consists of both text and |
| | tags widely used for performing document layout and performing |
| | hyperlinking. Java applets can be included using an <APPLET> tag. |
| | The current W3C version of HTML is HTML 4.0, which is also |
| | known as XML-compatible HTML (XHTML). |
| HTTP | Hypertext Transfer Protocol is the application protocol that controls |
| | the exchanging of files on the Web, and is within the architectural |
| | domain of W3C. |
| IE | Internet Explorer, the leading web-browser offered by Microsoft and |
| | provided free-of-charge with Microsoft operating systems. |
| Internet | A worldwide system of computer networks based on the TCP/IP set |
| | of protocols. Its most widely used parts are electronic mail (e-mail) |
| | and the World Wide Web (WWW). |
| Intranet | A private network that is contained within an enterprise using |
| | TCP/IP, HTTP, and other Internet protocols. Intranets may include |
| | connections through gateway computers to the Internet using |
| | firewall servers for security. |
| IP | Internet Protocol, protocol in the TCP/IP internet layer for |
| | communication between nets and their hosts. An IP-address |
| | uniquely identifies each network and each of its hosts on the |
| | internet. Addresses consist of four bytes that can be represented by |
| | four integers (0 to 255) separated by dots, e.g. “157.189.162.75”. |
| | Dependent on the address' class and a subnet mask, a specific |
| | number of bits identify the net or subnet and the rest a PC's address |
| | within this net/subnet. |
| ISO | ISO is the acronym for the International Organization for |
| | Standardization, which is an influential international federation of |
| | national standards organizations from over 100 countries. |
| Java | Java is an object oriented programming language that is cross- |
| | platform compatible and supports multithreading. Java is executed |
| | on any platform using the Java Virtual Machine (JVM). |
| Java Applet | A component written in Java, that can be downloaded from a server |
| | via an intra- or internet and executed on a client. The applet runs in a |
| | sandbox, e.g. the security settings only allow the applet to access |
| | data located on the server the applet is downloaded from. Most |
| | browsers contain a Java Virtual Machine (JVM) and are thus |
| | capable of running applets. |
| JavaBeans | JavaBeans refers to a Java component model where reusable “beans” |
| | are created using a Bean Development Kit (BDK). |
| Netscape | Netscape Navigator refers to Netscape's web-browser, which is |
| Navigator | currently part of Netscape Communicator. |
| SGML | Standard Generalized Markup Language is the standard for |
| | documents adopted in 1986 by the ISO for defining documents using |
| | DTDs. Document contents are identified by using semantic tags. |
| Tag | A tag is a vanilla term for a language element descriptor. Markup |
| | usually refers to the set tags for a document. |
| TCP | Transmission Control Protocol is a transport layer protocol, which is |
| | used to establish a proper connection (hand shaking) before any data |
| | is transmitted. |
| TCP/IP | Transmission Control Protocol/Internet Protocol refers to the two |
| | primary Internet protocols, namely the Internet Protocol IP (from |
| | which colloquial usage of the term “Internet” comes) and Transport |
| | Protocol TCP. It can also refer to certain application protocols, |
| | including FTP and telnet. |
| URL | Universal Resource Locator refers to the unique address of a |
| | document or a resource on the Internet. |
| W3C | The World Wide Web Consortium is an influential industry |
| | consortium promoting and maintaining the standards for the Web. |
| | The consortium also handles interoperability issues between Web |
| | products through its production of specifications and reference |
| | software. |
| WAP | Wireless Application Protocol refers to the primary standard for |
| | accessing the Internet using wireless devices. |
| WML | Wireless Markup Language refers to the DTD used in WAP. (see |
| | above) |
| WWW | World Wide Web, or simply Web, refers to the resources and users |
| | on the “Internet” using the Hypertext Transfer Protocol (HTTP). |
| XHTML | Extensible HyperText Markup Language refers to a reformulation of |
| | HTML 4.0 in XML 1.0. |
| XMLHTTP | This term refers to “Microsoft.XMLHTTP” or an “XMLHttpRequest |
| | Object”, which refer to the ActiveXControl enabling access to |
| | instances of HTTP request. |

VII. Law Community

A. Introduction

In the remainder of the description portion of the specification, the technology discussed in the foregoing sections is applied to a specific type of environment. Specifically, the embodiments are described with respect to an online person-to-person environment between attorneys and clients of the attorneys. In other words, the real-life “entities” or “user entities” that can be used with the present invention include clients, who require legal services and tasks to be performed, and attorneys, who provide such legal work and services for the clients.

However, it is important to note that method and apparatus described herein are equally relevant to other types of “entities,” including service providers and recipients, various legal entities, technical entities, and environments, for example, e-commerce or otherwise, wherever there is an interaction between two parties. As the present invention is not limited to use by clients and attorneys, it can be used or incorporated by any individuals who wish to pay for or barter for goods or services, and other individuals who provide such goods or services.

The service providers and service recipients are also not limited to persons, and can include businesses (such as partnerships, limited liability partnerships (LLPs), corporations, limited liability companies (LLCs), trusts), teaching institutions (such as universities, research facilities), governments (local, state, country), or any other entities legally entitled to use the present invention. Furthermore, the entities can also include machines (hardware and/or software) or other automated facilities affiliated with the aforementioned categories. For example, in the present invention, a “client” can be a corporation, a business unit of the corporation, or one or more processes representing the corporation or business unit. Therefore, although such terms as “client,” “attorney,” “client entity,” “attorney entity,” “client user entity,” and “attorney user entity” are used throughout, there are many other “entities” or “user entities” that can use and interconnect with the features and functions of the present invention.

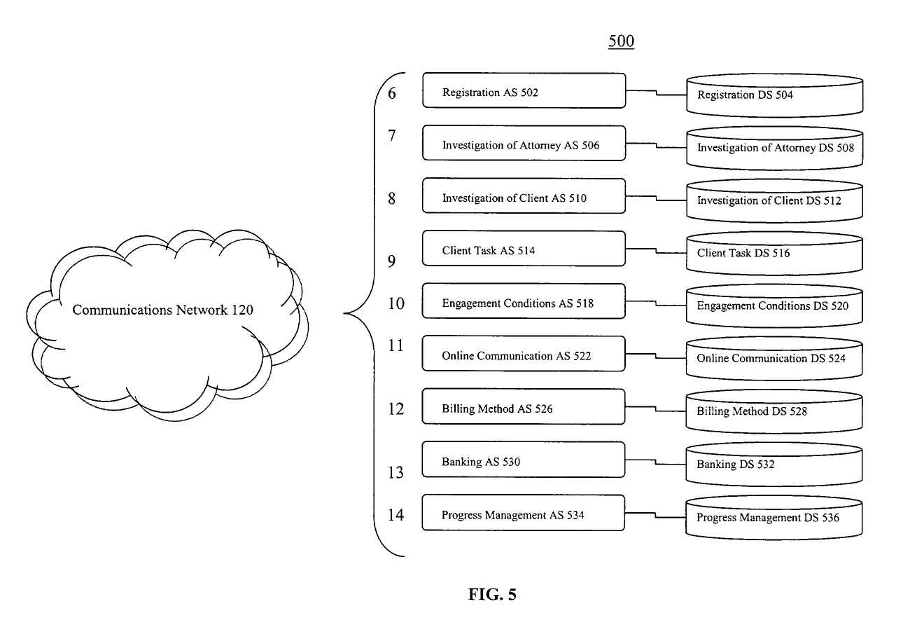

Referring to FIG. 5, the structure and functions of the present invention are described with respect to a modular structure, specifically through the application servers and database servers described with respect to FIG. 4. The application servers perform the described functions and database servers store one or more portions or subportions of the data accessed and otherwise used by the applications servers.

Each application server and/or database server shown is representative only, and can refer to a plurality of application servers and/or database servers working together. More importantly, as will be recognized by skilled persons, the features and functions described below are not limited to the example environment of FIG. 5, and can be performed by any of the technologies described above in sections I-VI.

Referring back to FIG. 5, illustrated are application server-database server pairs, specifically registration application server (AS) 502, registration database servers (DS) 504, investigation of attorney AS 506, investigation of attorney DS 508, investigation of client AS 510, investigation of client DS 512, client task AS 514, client task DS 516, engagement conditions AS 518, engagement conditions DS 520, online communication AS 522, online communication DS 524, billing method AS 526, billing method DS 528, banking AS 530, banking DS 532, and progress management AS 534, progress management DS 536.

The following embodiments describe the features and functions associated with the above-noted application servers, and exemplary types of data stored by the database servers. The embodiments also illustrate exemplary GUIs, for examples web pages, having one or more fields for informational content. The informational content can be (i) shown to individuals or entities, (ii) or stored, or maintained in the aforementioned database servers, or (iii) processed, downloaded, or uploaded by and from the aforementioned application servers, or (iv) processed, downloaded, or uploaded by and from client servers of user entities (for example, attorney, firm, and client user entities) who use the present invention. For example, a GUI can be displayed to an attorney user entity using browser 404 of client 402, or a client user entity using browser 404, 408 of client 406.

The name used for the user community service system of the present invention, including the associated features and functions, is termed “Law Community service system,” though skilled persons will recognize that any name or nickname can be used.

B. Registration

Registration AS 502 and DS 504 maintains and updates the contents for a Homepage for the Law Community service system users. Initially, the user (for example, attorney or client) enters a Law Community service system Homepage. The Homepage includes a variety of informational content for the user, differing varieties of which will be recognized by skilled persons. The standard Homepage features provide users the ability to: (i) initially register online, (ii) locate and track registered users who are currently online and who are not currently online, (iii) find personal and professional information on Law Community service system users, (iv) receive access to a site map, (v) create personalized web pages (or series of web pages) providing a user access to the Law Community service system features considered most important, and the ability to store personalized information (in one example embodiment, called myLawCommunity), (vi) sign in, if already registered as a user, or update personal features, if already registered, (vii) receive help information, if the user is new, or has not previously learned all the features and functions of the Law Community service system. There are also many other varied and unique features and functions provided to a Law Community service system user, as described in detail below.

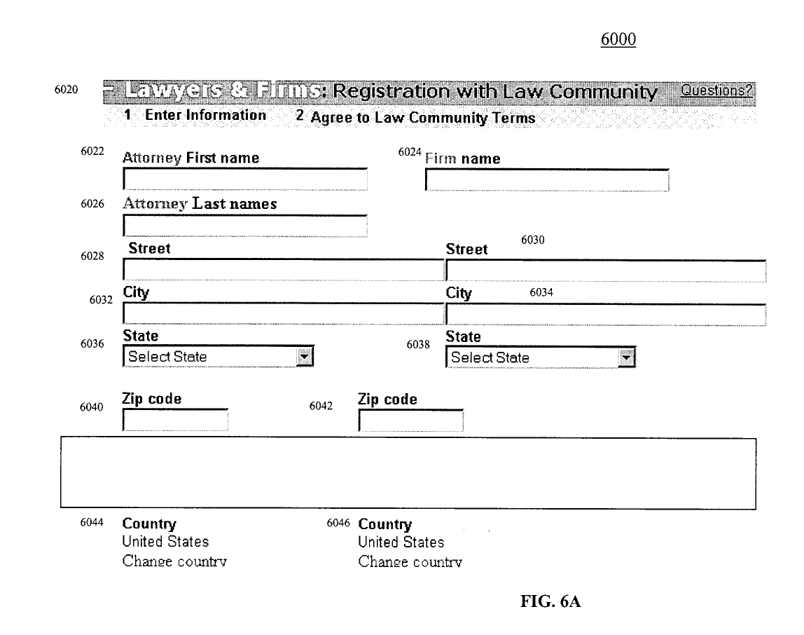

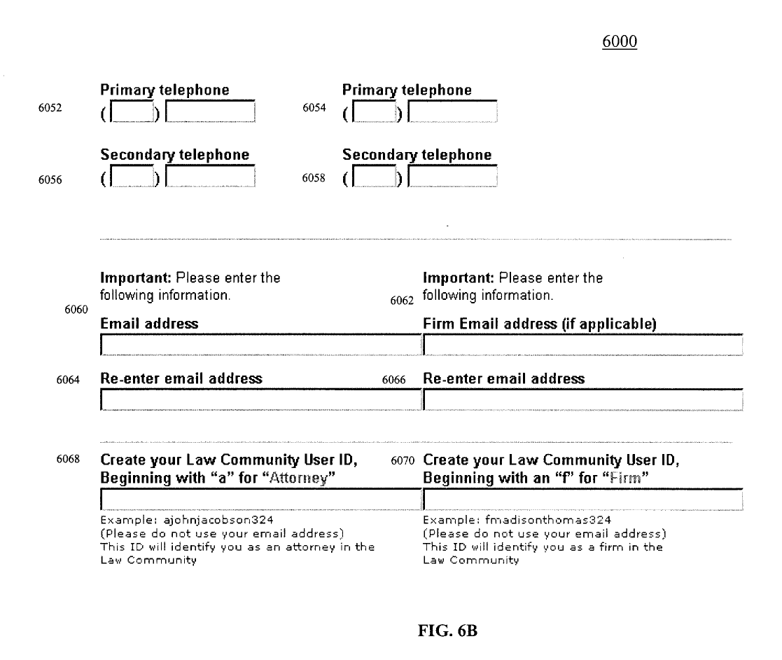

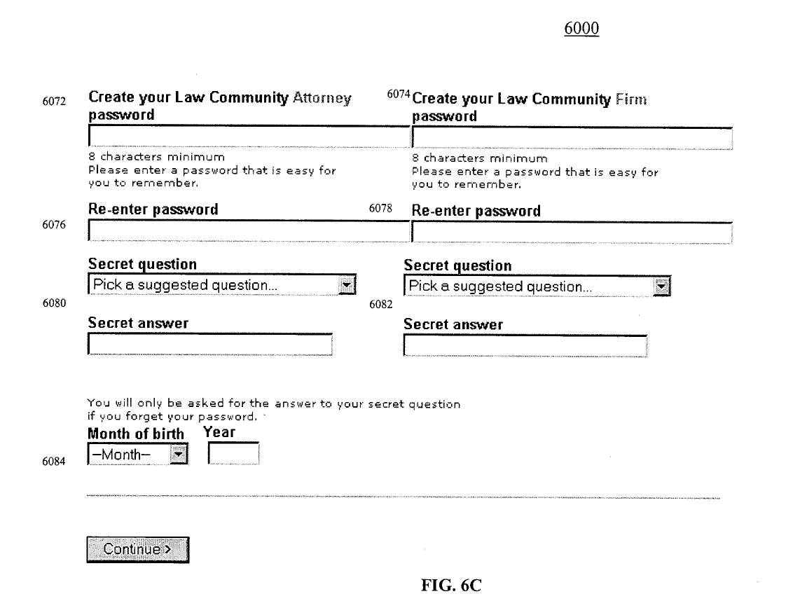

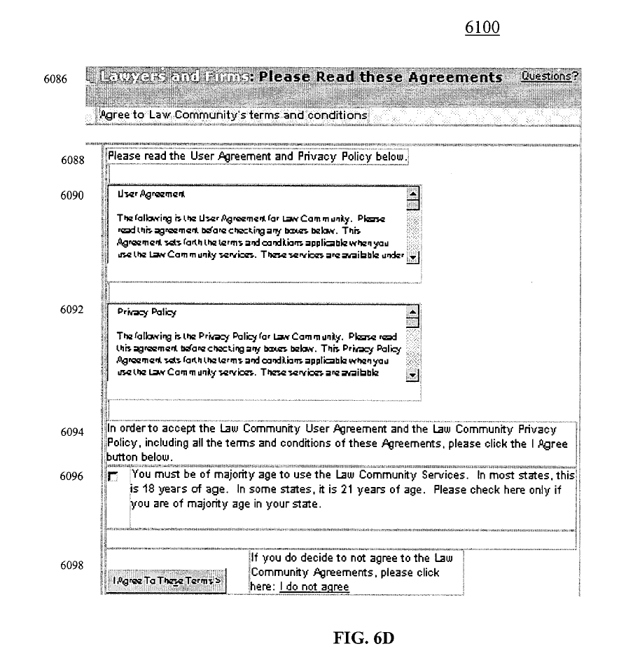

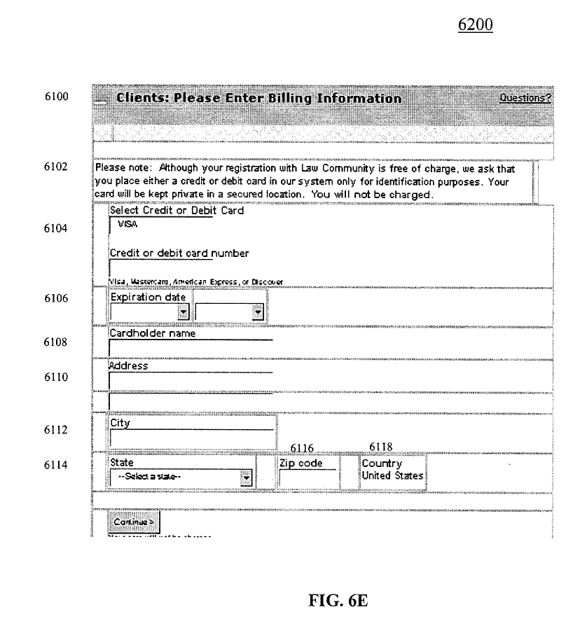

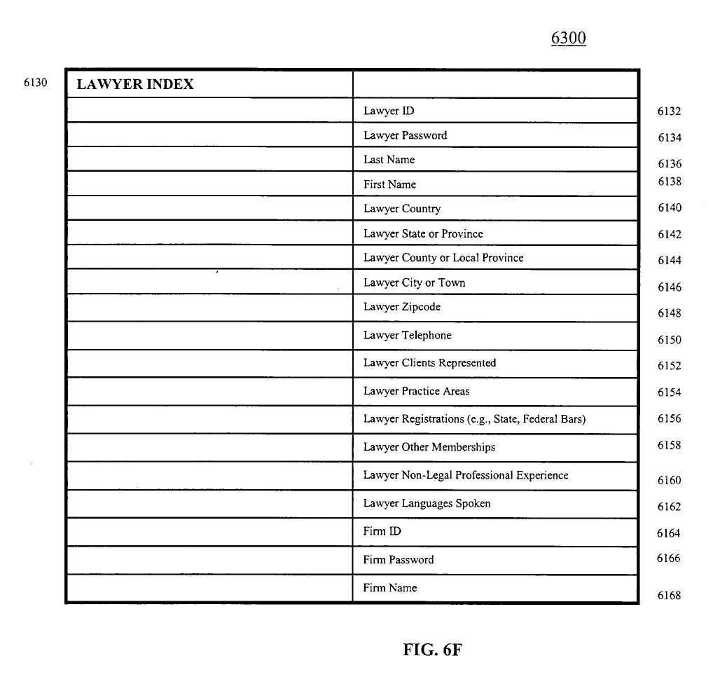

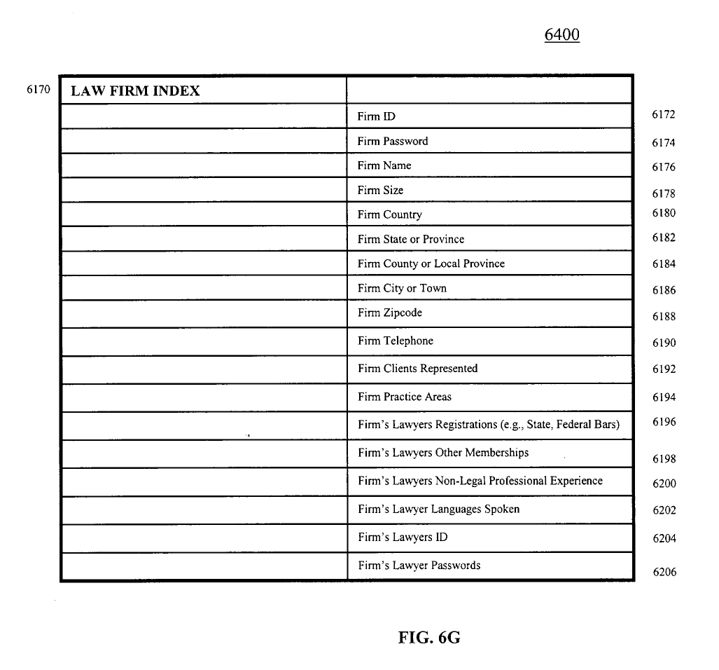

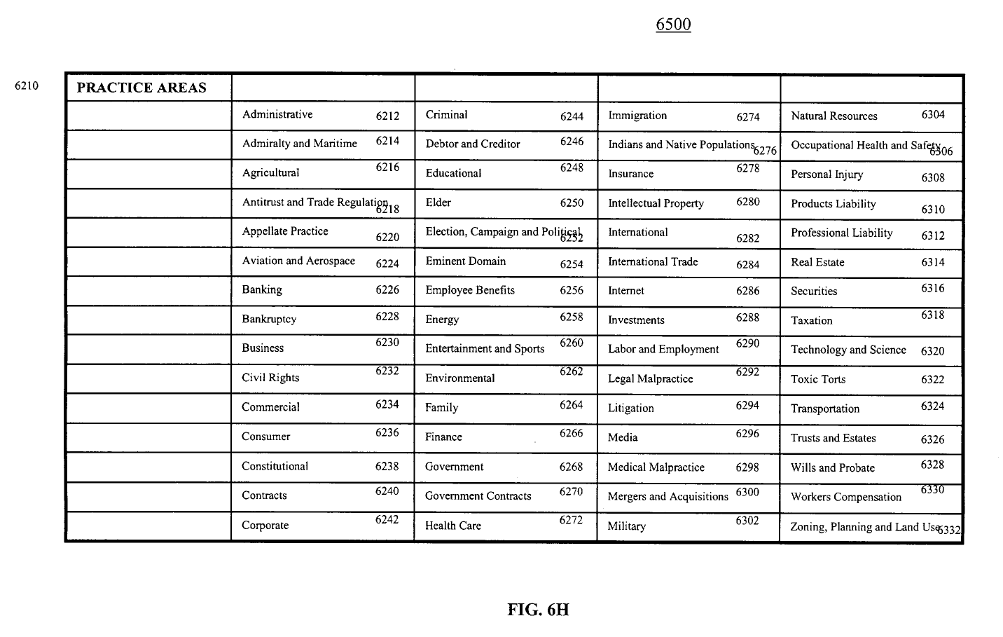

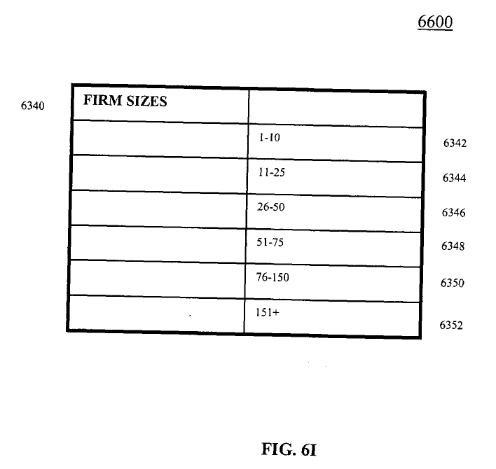

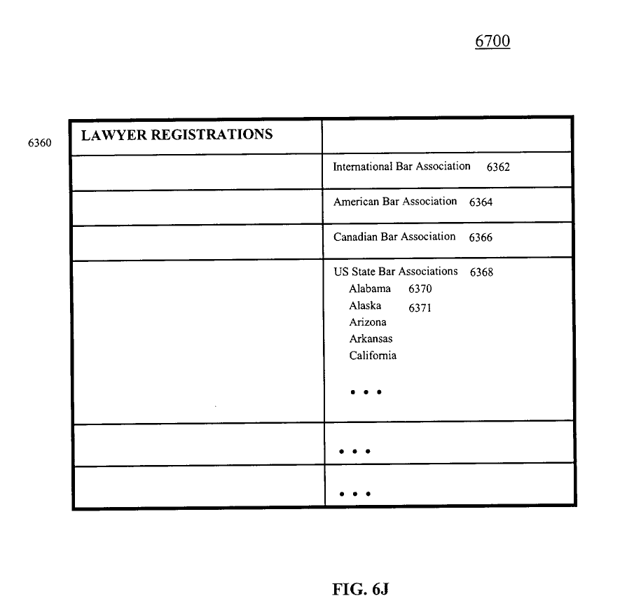

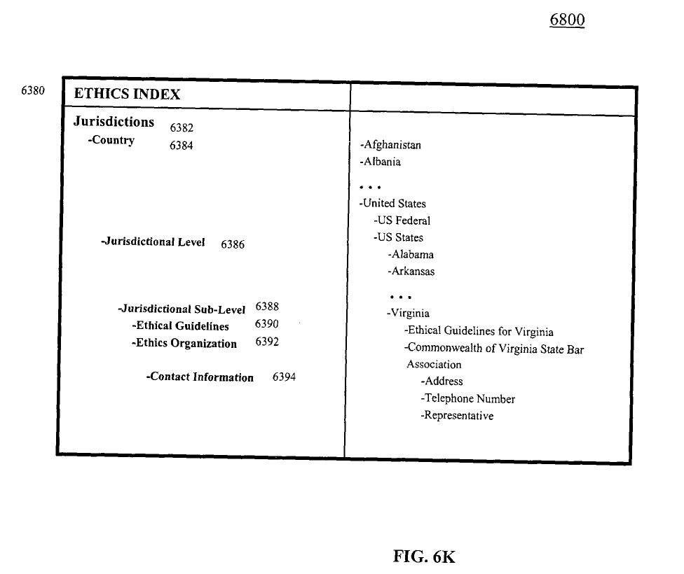

Registration AS 502 and DS 504 stores a variety of information for each user entity (including, for example, a client user entity, an attorney user entity, or law firm user entity) that uses the system. FIGS. 6A, 6B and 6C respectively illustrate the exemplary the first, second and third portions of a web page for registration of attorneys and law firms, which are stored, maintained, uploaded/downloaded, and processed on the Law Community service system. Table 3 includes a list of the fields that are displayed to attorney and firm entities, and solicit information from these users, for registration.

TABLE 3

| USER | |
|---|---|
| REGIS- | |
| TRATION | |
| FIELD | DESCRIPTION |
| 6020 | Identifies that the registration is for attorneys and firms. |
| 6022 | Attorney first name |
| 6024 | Firm name |
| 6026 | Attorney last name |
| 6028 | Attorney street address |
| 6030 | Firm street address |
| 6032 | Attorney city |
| 6034 | Firm city |
| 6036 | Attorney state |
| 6038 | Firm state |
| 6040 | Attorney zipcode |
| 6042 | Firm zipcode |
| 6044 | Attorney country |
| 6046 | Firm country |
| 6052 | Attorney primary telephone number |
| 6054 | Firm primary telephone number |
| 6056 | Attorney secondary telephone number |
| 6058 | Firm secondary telephone number |
| 6060 | Attorney e-mail address |
| 6062 | Firm e-mail address |
| 6064 | Re-entry of attorney e-mail address |
| 6066 | Re-entry of firm e-mail address |
| 6068 | A user-defined identification (userid or ID) for the attorney |
| | on the Law Community service system. In one embodiment, |
| | an attorney is required to make the first character of his/her |
| | userid begin with an “a” for attorney. |
| 6070 | A user-defined identification (userid or ID) for the firm on |
| | the Law Community service system. In one embodiment, a |
| | firm is required to make the first character of his/her userid |
| | (or ID) begin with an “a” for attorney. |
| 6072 | A password for the attorney on the Law Community service |
| | system. In one embodiment, the password is required to be at |
| | least 8 characters long, and can be defined by the attorney |
| | user. |
| 6074 | A password for the firm on the Law Community service |
| | system. In one embodiment, the password is required to be at |
| | least 8 characters long, and can be defined by the firm user. |
| 6076 | Re-entry of the attorney password, required for verification |
| | that the attorney user has correctly entered his/her password |
| | as he/she. |
| 6078 | Re-entry of the firm password, required for verification that |
| | the firm user has correctly entered his/her password as |
| | he/she. |
| 6080 | A secret question to be predefined by the attorney user, so |
| | that he/she can log into the system even if he/she forgets |
| | his/her password. In the illustrated embodiment, the attorney |
| | user selects the secret question from a predefined list. |
| 6082 | A secret question to be predefined by the firm user, so that |
| | he/she can log into the system even if he/she forgets his/her |
| | password. In the illustrated embodiment, the firm user |
| | selects the secret question from a predefined list. |
| 6084 | The user attorney inputs his/her month and date of birth. |
| 6086 | Identifies that the terms and conditions are for attorneys and |
| | firms. |
| 6088 | Advises attorneys and firms to please read the terms and |
| | conditions. |
| 6090 | The full user agreement for attorneys and firms. |
| 6092 | The full privacy agreement for attorneys and firms. |
| 6094 | Advises attorneys and firms to click a button to agree to the |
| | terms and conditions for using the Law Community service |
| | system. |
| 6096 | Advises the attorney or person signing in as a firm that they |
| | must be of age of majority. |
| 6098 | Permits the user to agree or not agree to the terms and |
| | conditions. |
| 6100 | Identifies for clients that the web page is for the entry of |
| | billing information. |
| 6102 | Client is advised that he/she will not be billed and that billing |
| | information is solicited only for signing up with the Law |
| | Community service system, and will be kept confidential. |
| 6104 | Client payment type (for example, VISA, AMEX) is |
| | solicited, as well as card number. |
| 6106 | Client payment type expiration date is solicited. |
| 6108 | Client name, as cardholder, is solicited. |
| 6110 | Client address information is solicited. |
| 6112 | Client city information is solicited. |
| 6114 | Client state information is solicited. |
| 6116 | Client zipcode information is solicited. |
| 6118 | Client country information is solicited. |

Skilled persons will recognize there are many ways the Law Community service system can store, maintain, upload/download and process the information for an entity using a browser 404 at client 402. In fact, any of the foregoing technologies can be used for these operations. As one example, that will be recognized to skilled persons, (i) the GUI interface (for example, web page) will be downloaded to browser 404 from registration AS 502, and the information entered by an entity at browser 404 will be uploaded to registration AS 502, using HTTP GET/POST commands; (ii) registration AS 502 will save the information at registration DS 504, and retrieve the information from registration DS 504, for downloads of requested information to browser 404 or processing of the information for downloads. Because these features and functions are known to skilled persons, and furthermore because an extensive discussion of various technologies that are used (and can be used) in the present invention were described above (in sections I-VI), such discussions will be omitted for the following embodiments.

Registration information for clients can be the same as the illustrated in FIGS. 6A-6C, or can be varied based on the needs of the Law Community service system, attorney, firm, or other user entities.

In one embodiment, users are requested to verify that they have read a user agreement and a privacy agreement. Again, this information is processed and maintained by the registration AS 502 and DS 504. FIG. 6D illustrates a web page GUI for this embodiment where the users are attorney or firm entities. Table 3 also includes a list of the fields that are displayed to attorney and firm entities, and solicit information from these user entities, for this embodiment. Verification of a client's review of a user agreement and a privacy agreement can be the same as illustrated in FIG. 6D, or can be varied based on the needs of the Law Community service system, individual attorneys, firms, or other entities. For example, it may be advantageous to have differing terms and conditions for clients than for attorneys and firms.

In one embodiment, billing information is solicited upon registration with the Law Community service system. Again, this information is processed and maintained by the registration AS 502 and DS 504. FIG. 6E illustrates a web page GUI for this embodiment where the users are client user entities. Table 3 also includes a list of the fields that are displayed to client user entities, and solicit information from these user entities, for this embodiment. Providing of billing information by other user entities, such attorney and firm user entities, can be the same as illustrated in FIG. 6E, or can be varied based on the needs of the Law Community service system and other entities. For example, it may be advantageous to have billing information provided only by clients upon registration, or to have the billing information provided by entities paying for services (for example, client user entities) processed differently than the billing information for entities providing such services (for example, attorney or firm user entities).

The above-noted information is not the only information that can be stored, maintained, uploaded/downloaded, and processed on the Law Community service system. Any information that would be useful for user entities, for example client user entities, attorney user entities, firm user entities, or other above-noted user entities, can be included and used in the present invention. Examples are illustrated and described below.

For example, registration AS 502 and DS 504 can store, maintain, upload/download and process any fields pertinent for attorneys. FIG. 6F illustrates an attorney index 6130, and numerous exemplary fields for attorneys. Illustrated are the following fields: Lawyer userid (or ID) 6132, Lawyer Password 6134, Last Name 6136, First Name 6138, Lawyer Country 6140, Lawyer State or Province 6142, Lawyer County or Local Province 6144, Lawyer City or Town 6146, Lawyer Zipcode 6148, Lawyer Telephone 6150, Lawyer Clients Represented 6152, Lawyer Practice Areas 6154, Lawyer Registrations (e.g., State, Federal Bars) 6156, Lawyer Other Memberships 6158, Lawyer Non-Legal Professional Experience 6160, Lawyer Languages Spoken 6162, Firm userid (or ID) 6164, Firm Password 6166, and Firm Name 6168.

There are also additional fields that can be stored, maintained, uploaded/downloaded, and processed on the Law Community service system for firms or other legal entities for whom attorneys work. Registration AS 502 and DS 504 can store, maintain, upload/download and process any fields pertinent for firms. FIG. 6G illustrates an attorney index 6170, and numerous exemplary fields for firms entities. Illustrated are the following fields: Firm userid (or ID) 6172, Firm Password 6174, Firm Name 6176, Firm Size 6178, Firm Country 6180, Firm State or Province 6182, Firm County or Local Province 6184, Firm City or Town 6186, Firm Zipcode 6188, Firm Telephone 6190, Firm Clients Represented 6192, Firm Practice Areas 6194, Firm's Lawyers Registrations (e.g., State, Federal Bars) 6196, Firm's Lawyers Other Memberships 6198, Firm's Lawyers Non-Legal Professional Experience 6200, Firm's Lawyer Languages Spoken 6202, Firm's Lawyers userid (or ID) 6204, and Firm's Lawyer Passwords 6206.

There are also additional fields that can be stored, maintained, uploaded/downloaded, and processed on the Law Community service system relating to legal practice areas of attorneys, for example, for the benefit of and use by client user entities or other user entities. Registration AS 502 and DS 504 can store, maintain, upload/download and process any such legal practice area fields. FIG. 6H illustrates a legal practice area index 6210, and numerous exemplary fields for legal practice areas. Illustrated are the following fields: Administrative 6212, Admiralty and Maritime 6214, Agricultural 6216, Antitrust and Trade Regulation 6218, Appellate Practice 6220, Aviation and Aerospace 6224, Banking 6226, Bankruptcy 6228, Business 6230, Civil Rights 6232, Commercial 6234, Consumer 6236, Constitutional 6238, Contracts 6240, Corporate 6242, Criminal 6244, Debtor and Creditor 6246, Educational 6248, Elder 6250, Election, Campaign and Political 6252, Eminent Domain 6254, Employee Benefits 6256, Energy 6258, Entertainment and Sports 6260, Environmental 6262, Family 6264, Finance 6266, Government 6268, Government Contracts 6270, Health Care 6272, Immigration 6274, Indians and Native Populations 6276, Insurance 6278, Intellectual Property 6280, International 6282, International Trade 6284, Internet 6286, Investments 6288, Labor and Employment 6290, Legal Malpractice 6292, Litigation 6294, Media 6296, Medical Malpractice 6298, Mergers and Acquisitions 6300, Military 6302, Natural Resources 6304, Occupational Health and Safety 6306, Personal Injury 6308, Products Liability 6310, Professional Liability 6312, Real Estate 6314, Securities 6316, Taxation 6318, Technology and Science 6320, Toxic Torts 6322, Transportation 6324, Trusts and Estates 6326, Wills and Probate 6328, Workers Compensation 6330, and Zoning, Planning and Land Use 6332.

There are also additional fields that can be stored, maintained, uploaded/downloaded, and processed on the Law Community service system relating to characteristics of the firm or other legal entities for whom the attorneys work. For example, it is possible to maintain information regarding the firm size, for example, for the benefit of and use by client user entities or other user entities. Registration AS 502 and DS 504 can store, maintain, upload/download and process any such firm size fields. FIG. 6I illustrates a firm size index 6340, and numerous exemplary fields for firm sizes, including firm size 1-10 field 6342, firm size 11-25 field 6344, firm size 26-50 field 6346, firm size 51-75 field 6348, firm size 76-150 field 6350, and firm size 151+ field 6352.

There are also additional fields that can be stored, maintained, uploaded/downloaded, and processed on the Law Community service system relating to characteristics of the attorneys, or of the attorneys of a firm or other legal entity for whom the attorneys work. For example, it is possible to maintain information regarding attorney memberships, associations, and geographical and/or jurisdictional areas where attorneys are registered to work. Registration AS 502 and DS 504 can store, maintain, upload/download and process any such memberships, associations, and geographical and/or jurisdictional area fields.

FIG. 6J illustrates a lawyer registration index 6360, and numerous exemplary fields for lawyer jurisdictions, including International Bar Association 6362, American Bar Association 6364, Canadian Bar Association 6366, and US State Bar Associations 6368, for US state bars Alabama 6370, Alaska 6371, etc.

There are also additional fields that can be stored, maintained, uploaded/downloaded, and processed on the Law Community service system relating to ethical entities and/or other professional societies that regulate attorney practices, whether attorneys work solo or at a firm or other entity. For example, it is possible to maintain information on US state bars for attorneys who practice in the United States. Registration AS 502 and DS 504 can store, maintain, upload/download and process any such ethical entity and/or professional society information.

FIG. 6K illustrates an ethics index 6380, and numerous exemplary fields relating to lawyer ethics guidelines, including for jurisdictions 6382 by country 6384, jurisdictional levels 6386 within a country, local jurisdictional sublevels 6388 (for example, the US state Virginia), ethical guidelines for a jurisdictional sublevel 6390 (for example, ethical guidelines for Virginia), the ethics organizations for a jurisdictional sublevel 6392 (for example, the Virginia State Bar), and contact information for ethics organizations (for example, the address, telephone numbers and representatives, such as Bar Counsel, for the Virginia State Bar).

Any user entity can search, query, browse, any categories relating to registration method, whether using information resident in the Law Community service system, or using external information.

C. Investigations of Attorneys

In these embodiments, a party receiving services (for example, a client user entity) can investigate and retrieve information regarding a service provider (for example, an attorney user entity or a law firm user entity). The investigation can be based upon any criteria or features associated with attorneys.

Investigation of attorneys information can be provided to and gathered from the attorney or firm user entities, for example at his/her browser 404, and stored, maintained, uploaded, downloaded, and processed on the Law Community service system, and processed and/or displayed for a client user entity at his/her browser 408. In these embodiments, the investigation of attorneys information is processed and maintained by the investigation of attorneys AS 506 and DS 508.

Any of the aforementioned fields provided to registration AS 502 and DS 504, during initial enrollment, in addition to any other fields, can be stored, processed, queried, browsed, or otherwise manipulated and displayed. Examples of the types of information that can be similarly stored, processed, queried, browsed, or otherwise manipulated and displayed include attorney information based upon (i) the region where the attorney resides or practices (for example, the country, the province, the state, the city, the locale); (ii) the jurisdiction or jurisdictions wherein the attorney is permitted to practice or maintain law offices; (iii) the attorney's practice area, whether general categories (for example, family law) or specific (for example, business transactions in the area of US government contracts); (iv) the reputation of the attorney in the Law Community service system (for example, the satisfaction levels of clients who have used the attorney, as described with reference to progress management AS 534 and DS 536 below); (v) the reputation of the attorney external to the Law Community service system (for example, published write-ups describing the client user entity likes or dislikes regarding the attorney user entity's performance); (vi) the attorney's accomplishments (for example, notable distinctions, offices held, resume information, clients represented, journal articles written, through the Law Community service system or externally, as for example in the Martindale Hubbel,™ directory, or in numerous other online directories); and (vii) comparable listings and calculations, showing a comparison of the attorney user entity being investigated by a client with other attorneys (for example, providing listings showing the relative billing rates for attorneys in a given geographical area, practice area, jurisdiction, or having a set number of years of experience, legal and/or technological background, as compared to the credentials of the attorney user entity being investigated).

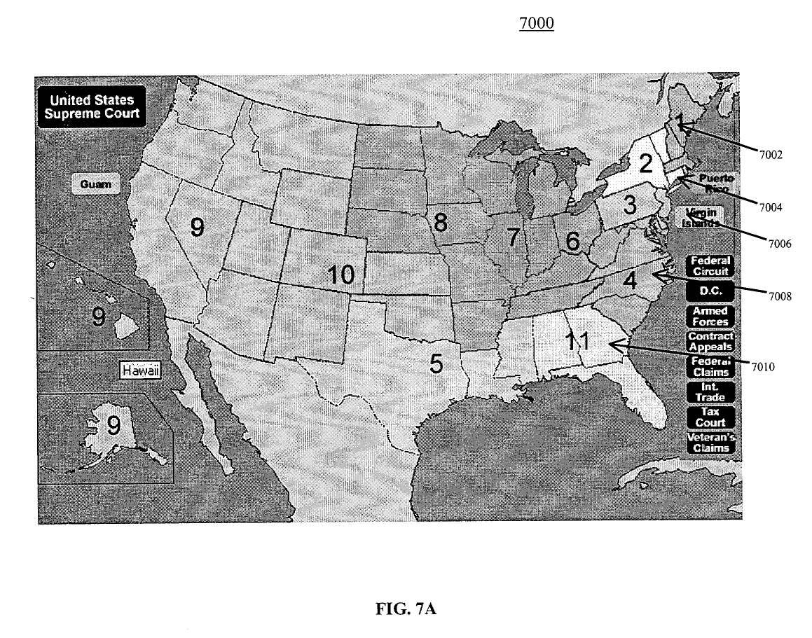

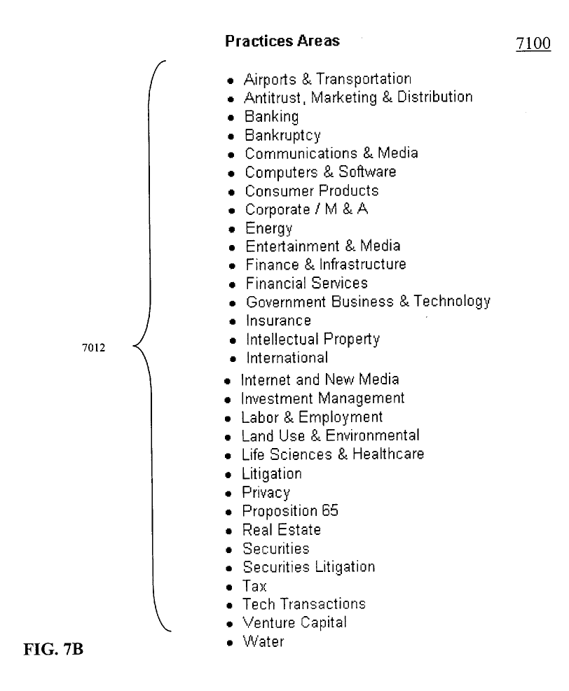

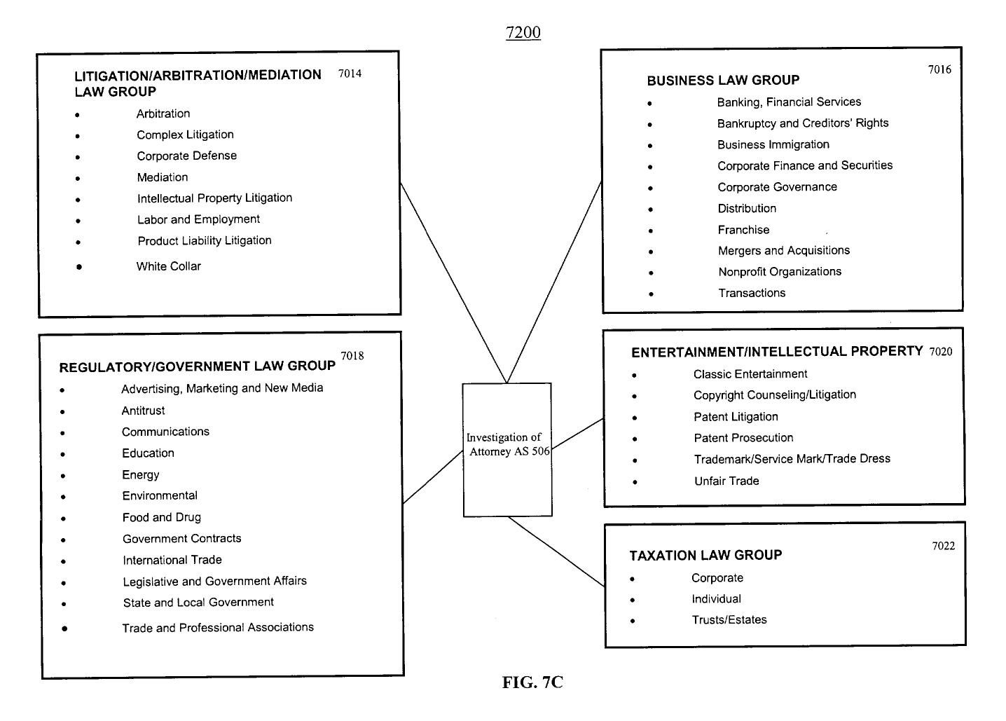

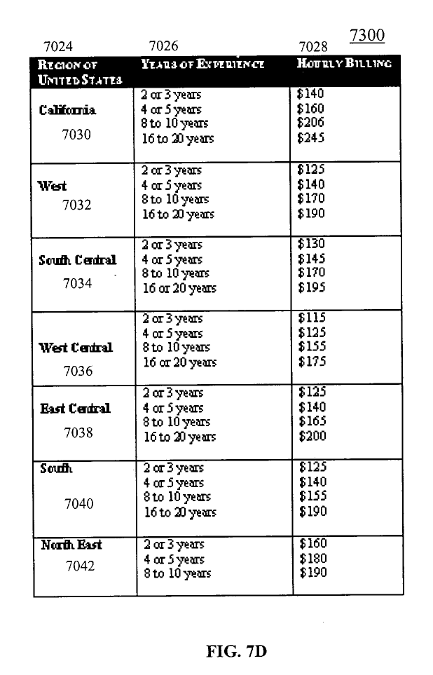

FIG. 7A illustrates an exemplary map of the United States territories 7000 that that can be illustrated to a client user entity, in his or her browser 408. The map is useful for a client user entity who desires to find an attorney user entity or law firm user entity.

In one embodiment, the client user entity desires to find an attorney qualified to practice within a particular US state jurisdiction. In this embodiment, the client user entity selects a particular state using his or her mouse, which hyperlinks to another web page (not shown) that includes all attorney user entities qualified to practice within the selected state.

In another embodiment, the client user entity desires to find an attorney qualified to practice within the federal courts of a particular US federal jurisdiction. In this embodiment, the client user entity selects a particular federal jurisdiction using his or her mouse, which hyperlinks to another web page (not shown) that includes all attorney user entities qualified to practice within the federal courts of the federal jurisdictional area. The federal jurisdictional areas are shown labeled numerically 1, 2, etc., with field 7002 pointing to the first federal jurisdiction (where the Court of Appeals for the First Circuit has appellate jurisdiction), field 7004 pointing to the second federal jurisdiction (where the Court of Appeals for the Second Circuit has appellate jurisdiction), field 7006 pointing to the third federal jurisdiction (where the Court of Appeals for the Third Circuit has appellate jurisdiction), field 7008 pointing to the fourth federal jurisdiction (where the Court of Appeals for the Fourth Circuit has appellate jurisdiction), and field 7010 pointing to the eleventh federal jurisdiction (where the Court of Appeals for the Eleventh Circuit has appellate jurisdiction).

The investigation of attorneys AS 506 and DS 508 can process and maintain information pertinent for attorneys in any particular manner desired by client user entities, and download such information for client user entities in their browser 408. For example, a client user entity can select to browse only the most populated legal practice areas in the Law Community service system. In response to an SQL query to DS 508, AS 506 receives and downloads to the client user entity's browser the exemplary list of the most populated legal practice areas illustrated in FIG. 7B. The client user can hyperlink from any of the shown practice areas 7012 to retrieve a list of attorney user entities with expertise in the selected practice area.

As another example, a client user entity can select to browse attorneys by law groups. Law groups are higher levels that each include their own legal practice areas. Again, in response to an SQL query to DS 508, AS 506 receives and downloads to the client user entity's browser the exemplary list of law groups having their own legal practice areas, as illustrated in FIG. 7C. The client user can hyperlink from any of the shown practice areas to retrieve a list of attorney user entities with expertise in the selected practice area.

FIG. 7C shows these the law groups: litigation/arbitration/mediation law group 7014, business law group 7016, regulatory/government law group 7018, entertainment/intellectual property group 7020, and taxation law group 7022. The law groups include practice areas as follows. Litigation/arbitration/mediation law group 7014 includes the practice areas: (i) arbitration, (ii) complex litigation, (iii) corporate defense, (iv) mediation, (v) intellectual property litigation, (vi) labor and employment, (v) product liability litigation, and (vi) white collar. Business law group 7016 includes the practice areas: (i) banking, financial services, (ii) bankruptcy and creditors' rights, (iii) business immigration, (iv) corporate finance and securities, (v) corporate governance, (vi) distribution, (vi) franchise, (vii) mergers and acquisitions, (viii) nonprofit organizations and (ix) transactions. Regulatory/government law group 7018 includes the practice areas: (i) advertising, marketing and new media, (ii) antitrust, (iii) communications, (iv) education, (v) energy, (vi) environmental, (vii) food and drug, (viii) government contracts, (ix) international trade, (x) legislative and government affairs, (xi) state and local government, and (xii) trade and professional associations. Entertainment/intellectual property group 7020 includes the practice areas: (i) classic entertainment, (ii) copyright counseling/litigation, (iii) patent litigation, (iv) patent prosecution, (v) trademark/service mark/trade dress, and (vi) unfair trade. Taxation law group 7022 includes the practice areas: (i) corporate, (ii) individual and trusts/estates.

FIG. 7D illustrates an exemplary manner in which comparable information regarding attorneys can be can be complied by AS 506 and DS 508 for a client user entity and displayed to him or her in browser 408. Illustrated are the hourly billing rates 7028, for attorneys having variable years of work experience 7026, working in various regions 7024 of the United States. The regions shown are California 7030, West 7032, South Central 7034, West Central 7036, East Central 7038, South 7040 and Northeast 7042. The comparable information helps a client user entity compare the billing rates of an attorney user entity on the Law Community service system with other attorneys in the US.

Any user entity can search, query, browse, any categories relating to the investigation of attorneys (or other service provider user entities), whether using information resident in the Law Community service system, or using external information.

D. Investigations of Clients

In these embodiments, a service provider (for example, an attorney user entity or a law firm user entity) can investigate and retrieve information regarding a party who receives services (for example, a client user entity). The investigation can be based upon any criteria or features associated with attorneys.

Investigation of client information can be provided to and gathered from the client user entities, for example at his/her browser 408, and stored, maintained, uploaded, downloaded, and processed on the Law Community service system, and processed and/or displayed for the attorney (or firm) user entity at his/her browser 404. In these embodiments, the investigation of client information is processed and maintained by the investigation of clients AS 510 and DS 512.

In one embodiment, any of the aforementioned fields provided to registration AS 502 and DS 504, during registration, can be stored, processed, queried, browsed, or otherwise manipulated and displayed. Examples of a variety of the types of information that can be similarly stored, processed, queried, browsed, or otherwise manipulated and displayed include client information based upon (i) the region where the client's business or businesses operate, and relative legal work loads required per region (for example, the country, the province, the state, the city, the locale); (ii) the decision makers, in-house counsel, and other key players who will be accessing attorney work, that can be broken down into varying legal work areas (for example, a patent review committee located in California will review patent applications, and in-house corporate counsel located in Arizona will review employee related matters); (iii) the client's industry area and sub-areas, business divisions and sub-divisions; (iv) the client's points of business and technology novelty; (v) the reputation of the client in the Law Community service system (for example, the satisfaction levels of attorneys who have worked for the client, including for example how timely client's bills are paid, the client's management style, flexibility to alternative billing methods, loyalty to attorneys who have worked for them, demands placed upon attorneys for the work performed); (vi) the reputation of the client external to the Law Community service system (for example, publications regarding the CEO's business acumen, the client's perceived potential in on Wall Street); (vii) the client's accomplishments (for example, notable distinctions in the business community or in a technology area, information and analyses gathered from data miners such as Gartner Group™ and Yankee Group™, independently obtained information such as white papers and press releases); and (viii) comparable listings and calculations, showing a comparison of the client user entity being investigated by an attorney with other clients (for example, listings showing the investigated client's timeliness of paying bills as compared with other clients in a given geographical area, industry area, with similar business success).

The investigation of clients AS 510 and DS 512 can process and maintain pertinent information regarding clients in any particular manner desired by a service provider (for example, an attorney or firm user entity), and download such information in their browser 404. For example, an attorney user entity can select to browse only the most populated industry areas in the Law Community service system. In response to an SQL query to DS 512, AS 510 receives and downloads to the attorney user entity's browser the exemplary list of the most populated industry areas. The client user can then hyperlink from these industry areas to retrieve a list of client user entities in the selected industry areas.

As another example, a client user entity can select to browse the clients within a particular industry area and sub-areas, because the attorney has great experience in such areas. In response to an SQL query to DS 512, AS 510 receives and downloads to the attorney user entity's browser the requested list of industry areas and sub-areas.

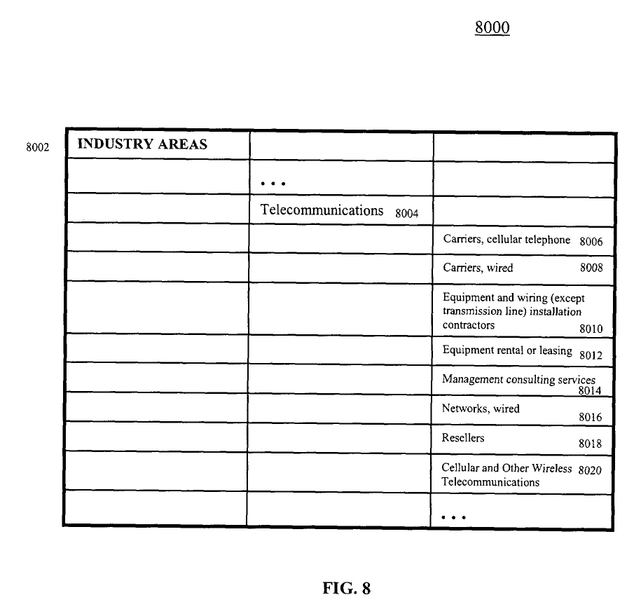

FIG. 8 illustrates such an exemplary industry area database that can be shown to an attorney user entity, in his or her browser 404, when investigating a client user entity. There are many industry areas 8002, of which only the telecommunications industry area 8004 is shown. The telecommunications industry area 8004 includes a number of sub-areas, including: carriers, cellular telephone 8006, carriers, wired 8008, equipment and wiring (except transmission line) installation contractors 8010, equipment rental or leasing 8012, management consulting services 8014, networks, wired 8016, resellers 8018, and cellular and other wireless telecommunications 8020. The attorney user entity can hyperlink from any of the sub-areas to retrieve a list of all client user entities on the Law Community service system who fall within such a sub-area.

Any user entity can search, query, browse, any categories relating to the investigation of clients (or other service recipient user entities), whether using information resident in the Law Community service system, or using external information.

E. Client Task

In these embodiments, a party who desires to receive services (for example, a client user entity) can post a listing of the services for viewing and establishing of an engagement relationship with a service provider (for example, an attorney user entity or a law firm user entity). The information provided by the party who desires to receive services can be any information such party and/or a service provider will deem important in establishing an engagement relationship, whether internal to the Law Community service system or external to it.

The aforementioned information can be extracted from, for example, a client user entity, using his or her browser 408, with the information being stored, maintained, uploaded, downloaded, and processed on the Law Community service system, and processed and/or displayed for the attorney (or firm) user entity at his/her browser 404. In these embodiments, the processing and maintaining of information is performed by the client task AS 514 and DS 516.

In one embodiment, any of the aforementioned fields and information provided to registration AS 502 and DS 504, during initial enrollment, can be stored, processed, queried, browsed, or otherwise manipulated and displayed. In another embodiment, any of the fields and information provided to progress management AS 534 and DS 536, which are described below in detail, can be stored, processed, queried, browsed, or otherwise manipulated and displayed. Table 6 is especially relevant in this context.

The manner in which the client provides criteria regarding the client tasks can be provided to the Law Community service system, where it can be stored, processed, queried, browsed, or otherwise manipulated and displayed, can be of any variety. Examples include (i) providing a written description of the legal work on a Law Community service system web page; (ii) transmission of a file including the information; (iii) reference to a web page URL including the information.

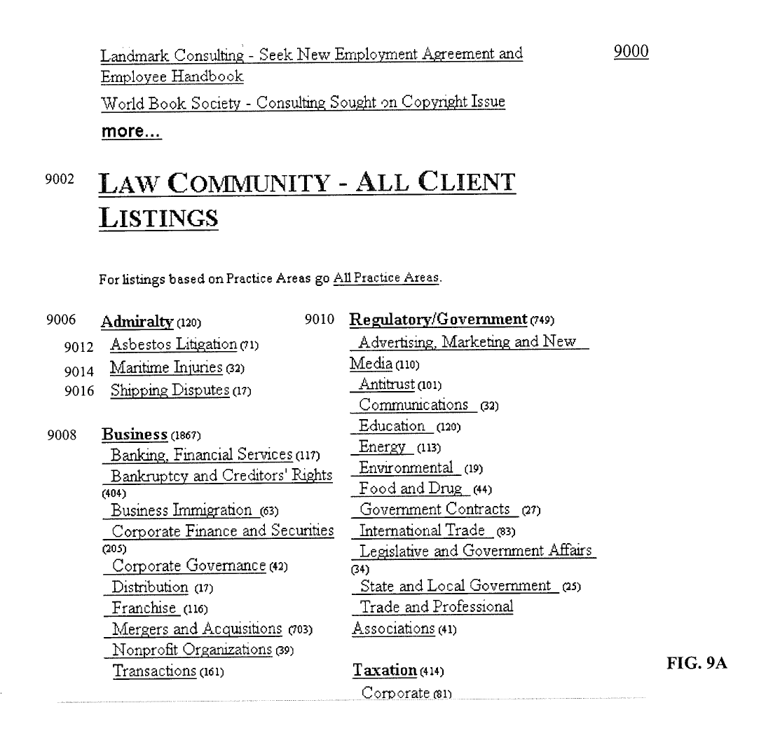

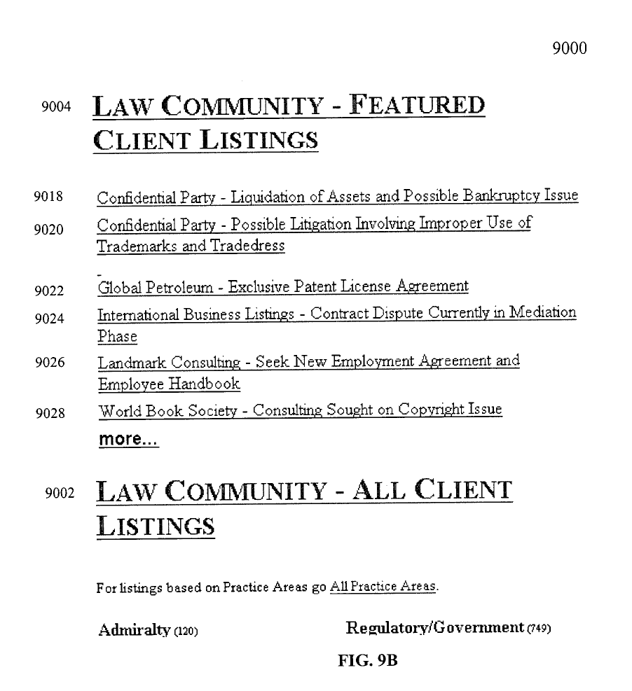

The manner of displaying the client task criteria can take any format as well. FIGS. 9A illustrates Law Community service system client listings 9002. This is a comprehensive list of client listed legal work based on practice areas. The legal practice areas of admiralty 9006, business 9008, and regulatory/government 9010 are shown. Each practice area shown includes hyperlinks to specific sub-areas within the legal practice areas. For example, admiralty 9006 includes sub-area hyperlinks asbestos litigation 9012, maritime injuries 9014 and shipping disputes 9016. Each practice area also shows a number next to it in parentheses, which is the total number of client listings on the system under the particular practice area. For example, the admiralty practice area 9006 includes “(120)” meaning that there are 120 different client listings under the admiralty practice area.

Each sub-area within a practice area also shows a number next to it in parentheses, which is the total number of client listings on the system under the particular sub-area. For example, of the 120 different client listings under the admiralty practice area 9006, 71 belong to asbestos litigation sub-area 9012, 32 belong to maritime injuries sub-area 9014 and 17 belong to shipping disputes sub-area 9016.

FIG. 9B illustrates featured client listings 9004, which are client criteria that are featured by the Law Community service system. Featured listings 9018-9028 are shown, which are hyperlinks to more specific information for each listings. As shown, client identities can remain confidential (for example, until there is engagement) or can be provided to user entities on the system.

In one or more embodiments, any user entity can set any fields accessible by the Law Community service system (including their own identities, or any other fields relating them, as mentioned in this written description at varying privacy levels. For example, a law firm user entity may set his or her identity and billing rate to be confidential from other law firm user entities and attorney user entities, but freely accessible by client user entities. As another example, an attorney user entity may permit his or her client user entities, including all sub-user entities (representing various affiliates of the client user entity) to view the satisfaction level of the client user entity with his or her work efforts, but not permit the same by other client user entities, or attorney or firm user entities.

Any user entity can search, query, browse, any categories relating to the client work criteria, whether using information resident in the Law Community service system, or using external information.

F. Engagement Conditions

In these embodiments, user entities are permitted to establish online agreements with one another. For example, a client user entity is permitted to agree to an engagement with an attorney user entity or with a law firm user entity. Any type of engagement can be mutually agreed to by the parties, which will establish a client-attorney relationship.

Communication information can be provided to and gathered from the entity, for example at his/her browser 404, and stored, maintained, uploaded, downloaded, and processed on the Law Community service system. In these embodiments, the communication information is processed and maintained by the engagement conditions AS 518 and DS 520.

The engagement conditions can be previously prepared terms and conditions for an engagement agreement, as found in many types of client-attorney engagement letters. A brief, non-exhaustive list of exemplary terms and conditions is found in Table 4.

TABLE 3
ALTERNATIVE BILLING METHOD

PREAMBLE
Client and Attorney hereby enter into this agreement regarding the retention of Attorney
by Client to provide legal advice and services:
CLIENT IDENTIFICATION
To the extent ethically permissible, Client's officers, directors, employees, and agents
should also be treated as clients, unless Client advises otherwise or Attorney cannot
ethically represent such individuals in addition to Client.
ATTORNEY IDENTIFICATION
Attorney is licensed to practice law in any and all jurisdictions relevant to the legal
matters being agreed to. Attorney agrees to be responsible for managing the
representation in the event he/she practices with others, and such other individuals are
permitted by client to provide client services. Attorney further agrees to assure
compliance of such others individuals with the terms of this agreement as well as ethical
requirements. Attorney will be responsible for the preparation and substantiation of bills,
and all communications with Client.
SUBJECT MATTER GENERALLY
Client: Please provide a description of the subject matter. Attorney agrees that he/she is
retained by Client in connection with this subject matter. Attorney represents his/her
competency in connection with this subject matter. This clause shall apply to any
additional subject matter that may be consented to by both parties.
THE MATTER SPECIFICS
. . .
Ethical Obligations
Upon investigation, Attorney has found that neither he/she nor his/her firm has any
ethical impediments to representing Client.
ATTORNEY FEE
The parties agree that Attorney will be paid based on the number of hours spent working
on subject matter (rounded to the nearest tenth of an hour) multiplied by the Attorney's
hourly rate of $ 325. Details regarding bills, documentation, and time-keeping are
provided below and are a condition precedent to payment by the Client.
BILLING OF FEES AND EXPENSES
Attorney agrees that the bills will be issued monthly within 30 days after the close of
each month unless otherwise agreed to in writing and signed by Client.

In one embodiment, the client and/or attorney can mutually assent to engagement conditions provided over a GUI interface in their respective browsers 404, 408. The engagement process can be begun by either user entity, with the other user entity being notified of the first user entity's preferences and having a chance to either agree to the engagement conditions, or making changes to the conditions. In this embodiment, the process toggles back and forth, until both parties agree to the engagement conditions.

For example, initially a client entity can be shown a GUI interface including attorney-client engagement conditions, with the client entity having one or more options to choose from on the GUI interface. The GUI can include numerous default settings, making the decision making process simpler for the client, or “standard” to engagement letters used throughout a particular community, geographical region, or jurisdiction. Upon the client's “checking off” the desired choices, a message is transmitted to the attorney chosen by the client, which will include a hyperlink to the engagement conditions, including the values preselected by the client. The attorney can then choose to agree to all the engagement conditions desired by the client, whereupon notification of acceptance is transmitted to the client, or the attorney can instead choose to change one or more of the conditions, whereupon notification of a an engagement agreement with changed conditions is transmitted to the client.

Upon receipt of attorney's acceptance of the client's engagement conditions, the client can choose to acknowledge and verify his/her acceptance of the agreement. On the other hand, upon receipt by client that the attorney has changed one or more of the engagement conditions, the client can choose to agree to the changed conditions or refuse acceptance. Once again, the attorney is made aware of the client's decision, and is given the opportunity to respond once again.

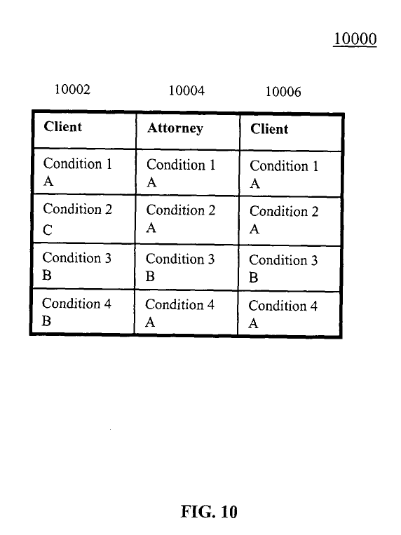

FIG. 10 provides an exemplary illustration of the above-described toggle method. Initially, the client chooses conditions 1002, including engagement condition 1 as A, engagement condition 2 as C, engagement condition 3 as B, and engagement condition 4 as B. Next, the attorney is given notice of client's preferred engagement conditions, and chooses conditions 1004, including engagement condition 1 as A (agreement with client condition), engagement condition 2 as A (disagreement with client condition), engagement condition 3 as B (agreement with client condition), and engagement condition 4 as A (disagreement with client condition). Next, the client is given notice of attorney's responses to his/her preferred engagement conditions, and notices that the attorney has agree to engagement conditions 1, 3, but has disagreed with conditions 2, 4. At this point, the client chooses to agree to the changes proposed by the attorney, and verifies acceptance of conditions 1-4.

Any user entity can search, query, browse, any categories relating to the engagement conditions method, whether using information resident in the Law Community service system, or using external information.

G. On-Line Communication

In these embodiments, users, including the aforementioned entities are provided facilities with which to communicate with one another. This communication can occur at any point, including before engagement of an attorney or other service provider. The communication can be between any types of entities, for example, between two clients, between an attorney and a client, between two attorneys, and between a firm and a client.

Any type of online communication can take place. Communications network 120 provides wireline communications capability, wireless communications capability, or a combination of both, at any frequencies, using any type of standard, protocol or technology. The applications can be of any type as well, including message threads, chats, and streaming video such as webcasts, to name a few. As used herein, threads refer to bulletin board systems (BBSs), related newsgroups, or e-mail messages, or the like, on a subject, including an original message and subsequent replies.

Newsgroups are, for example, an electronic discussion group with collections postings or articles that are related on a given topic. The postings are posted to news servers that distribute them to other participating servers. BBS as used herein is a system permitting individuals to read one another's messages and post their own messages, with the Usenet being the largest distributed BBS in the world.

Email as used herein refers to electronic mail, comprised of messages, including text, figures, web pages, sent between individual users. Chat as used herein refers to “real time” communication over the Internet, though in general individuals performing online chat type messages to one another and a message appears on the screen of individual being communicated with. It is possible to compartmentalize chats between different users based on mutual interests in what are called chat rooms.

Video streaming as used herein refers to downloading of videos and other content from servers and viewed on the client user entity's browser. Webcasting as used herein refers to video streaming to user entities at a rate that matches their network connection speeds, permitting each user to watch the content as it arrives.

Communication information is provided to and gathered from the user entity, for example at his/her browser 404, 408, and stored, maintained, uploaded, downloaded, and processed on the Law Community service system. In these embodiments, the communication information is processed and maintained by the online communication AS 522 and DS 524.

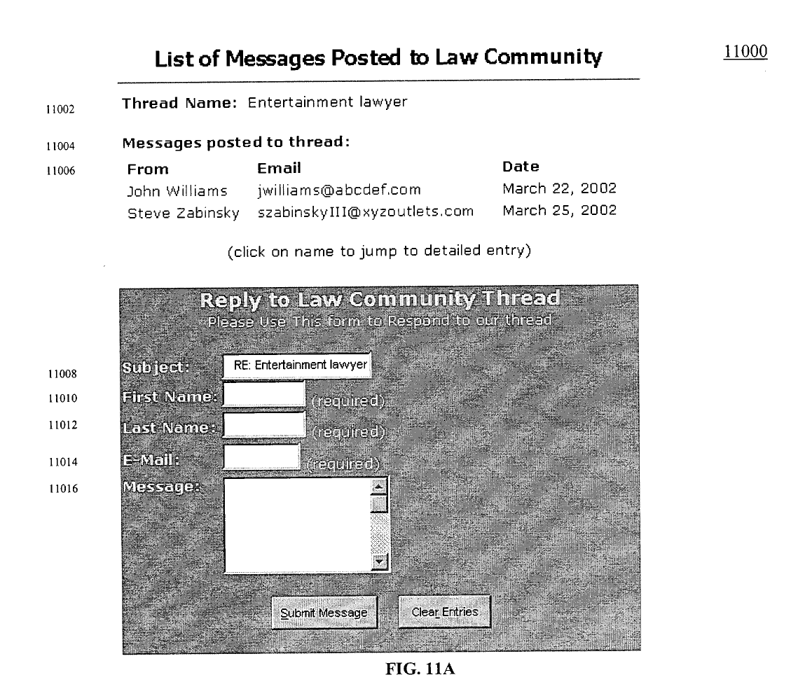

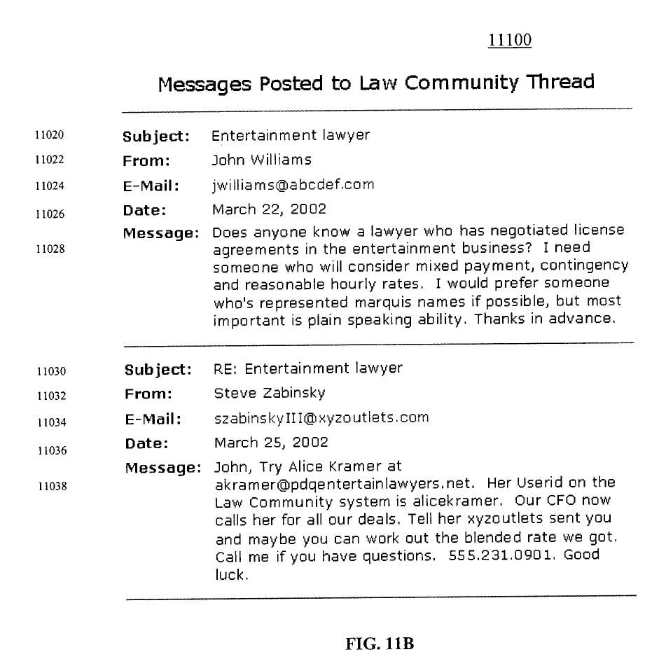

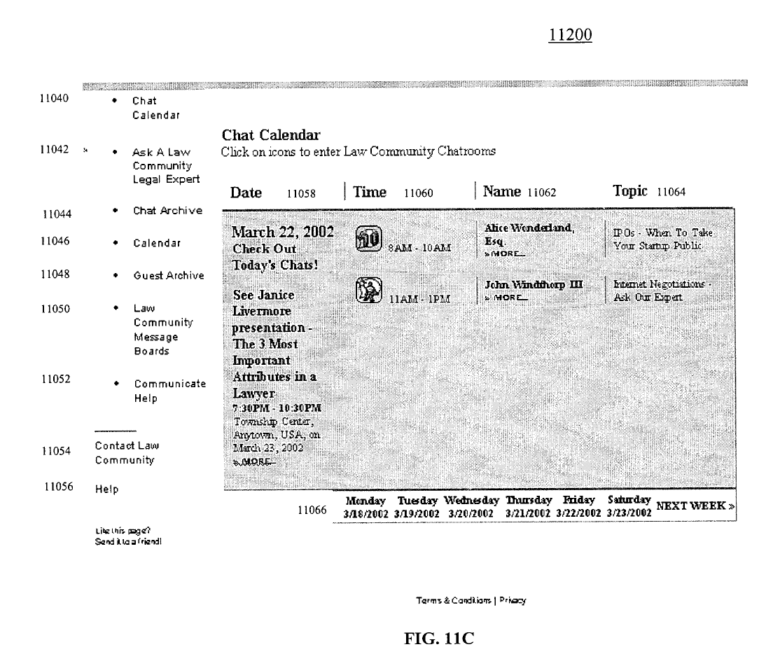

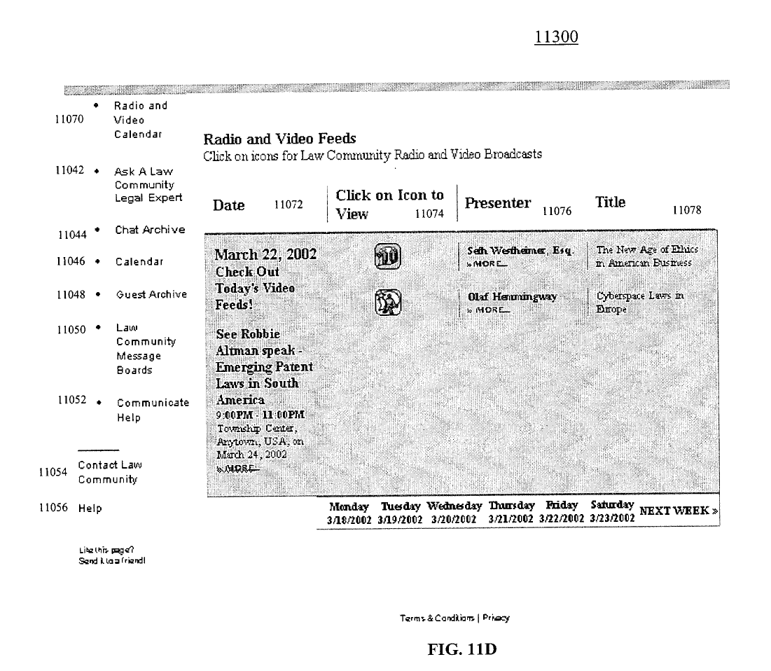

FIG. 11A illustrates an exemplary web page GUI for a discussion thread, specifically messages posted to the Law Community service system. Illustrated are information fields relating to a thread regarding the search for an entertainment lawyer, including the thread name 11002, messages posted to the thread 11004, and information fields 11006 showing who posted the thread, the person's e-mail address, and the date the thread was posted. John Williams has posted a first thread on the subject on Mar. 22, 2002, and Steve Zabinsky has posted a second thread on Mar. 25, 2002. A user entity can post his or her own thread in response to the subject (shown as subject 11008) by filling in their first name 11010, last name 11012, e-mail (or Law Community service system userid or ID) 11014, and message 11016.

FIG. 11B illustrates the content of the threads originally posted, including for John Williams, subject field 11020, from field 11022, e-mail field 11024, date field 11026, and message field 11028, and for Steve Zabinsky, subject field 11030, from field 11032, e-mail field 11034, date field 11036, and message field 11038.

FIG. 11C illustrates an exemplary web page GUI for chat discussions, for example, messages posted to the Law Community service system. Illustrated is what a user entity views when he or she clicks on a chat calendar hyperlink 11040 on the left of the webpage. Included are the dates that chats will be conducted and monitored 11058, the times 11060, the persons Law Community service system members can chat with 11062, the topics for discussion 11064, and a hyperlink to other days 11066.

Also illustrated are hyperlinks to additional services that that can be processed and maintained by the online communication AS 522 and DS 524. Included are ask a Law Community service system Legal Expert hyperlink 11042 (which permits user entities to conduct threads and/or chats with known industry and attorney experts), chat archive hyperlink 11044 (which permits user entities to view archives of previous chats), a calendar hyperlink 11046 (which permits user entities to maintain their own personalized calendars for chats and discussion threads), a guest archive hyperlink 11048 (which permits a user entity to view previous Law Community service system guests for chats and/or threads), Law Community Message Boards hyperlink 11050 (which permits a user entity to post or see threads, as illustrated in FIGS. 11A, 11B), communicate help hyperlink 11052 (which provides user entities instructions for communicating online in the Law Community service system), contact Law Community hyperlink 11054 (for connecting user entities to individuals who run the Law Community service system), and help hyperlink 11056 (which provides user entities help regarding the Law Community service system).

FIG. 11D illustrates an exemplary web page GUI for permitting user entities to hear, see and transmit radio and video feeds, for example, radio and video feeds that can be downloaded from the Law Community service system. Illustrated is what a user entity views when he or she clicks on a radio and video calendar hyperlink 11070 on the left of the webpage. Included are the dates radios and videos can be downloaded 11072, the hyperlink icons that can be used to provide the downloads 11074, the individuals who make the presentations 11076, and the titles of the broadcasts 11078.

Any user entity can search, query, browse, any categories relating to the online communication method, whether using information resident in the Law Community service system, or using external information.

H. Billing Method

In these embodiments, a party who desires to receive services (for example, a client user entity) and service provider (for example, an attorney user entity or a law firm user entity) can offer one another and mutually agree to a billing fee arrangement. Any type of fee arrangement is permitted and anticipated, including standard billing arrangements, alternative fee billing arrangements and online auctions. The information provided can be internal to the Law Community service system or extracted from information external to it. This information can help a client user entity determine whether to engage the services of an attorney or law firm user entity.

The aforementioned information can be extracted from, for example, attorney or law firm user entities, using their browsers 404, with the information being stored, maintained, uploaded, downloaded, and processed on the Law Community service system, and processed and/or displayed for the client user entity at his/her browser 408. In these embodiments, processing and maintaining of the information is performed by the billing method AS 526 and DS 528.

Standard billing methods that can be employed include fixed fee, contingent fee, hourly fee, and retrospective based on value arrangements. Fixed fee is valuable where the services can be easily and precisely defined, so that the scope of engagement may be foreseen by the user entities with some amount of certainty. In a contingent fee arrangement, a portion or all of the fee paid to attorney or law firm user entities is based on the results obtained for the client user entity. In hourly fee, the basis for payment is purely on the number of hours spent by attorney or law firm user entities in performing the client user entity's legal work. In a retrospective based on value arrangement, the fee is determined somewhat subjectively through mutual cooperation between and subjective evaluation of the user entities after the client user entity's legal work has been performed.

In a number of embodiments, the legal work is performed based on an online auction basis. There are two general embodiments for each type of auction. (i) The first embodiment is where the service recipient user entity (for example, the client user entity) bids on services offered by the service provider user entity (for example, the attorney or firm user entity) on the Law Community service system. (ii) The second embodiment is where the service provider user entity (for example, the attorney or firm user entity) bids on work offered by a service recipient user entity (for example, the client user entity) offered on the Law Community service system. Any type of auction known or anticipated by skilled persons can be held. It is important to note that any of the information available on the Law Community service system can be used in the auction process. In one or more embodiments, the legal work posted by clients (or other service recipient user entities) and bid upon by attorney user entities (or other service provider user entities) includes the universal projects, projects, and tasks listed in Table 6, including any sub-categories or other characteristics thereof, whether offered by a single or group collaboration of client user entities other service recipient user entities. In one or more embodiments, the legal services posted by attorneys (or other service provider user entities) clients and bid upon by clients (or other service recipient user entities) includes standard billing arrangements, alternative fee billing arrangements, whether described herein or known to skilled persons, including any sub-categories or other characteristics thereof, whether offered by a single or group collaboration of attorney user entities, firm user entities or other service provider user entities. The aforementioned comments apply to any of the auctions mentioned in Table 4 or known to skilled persons.

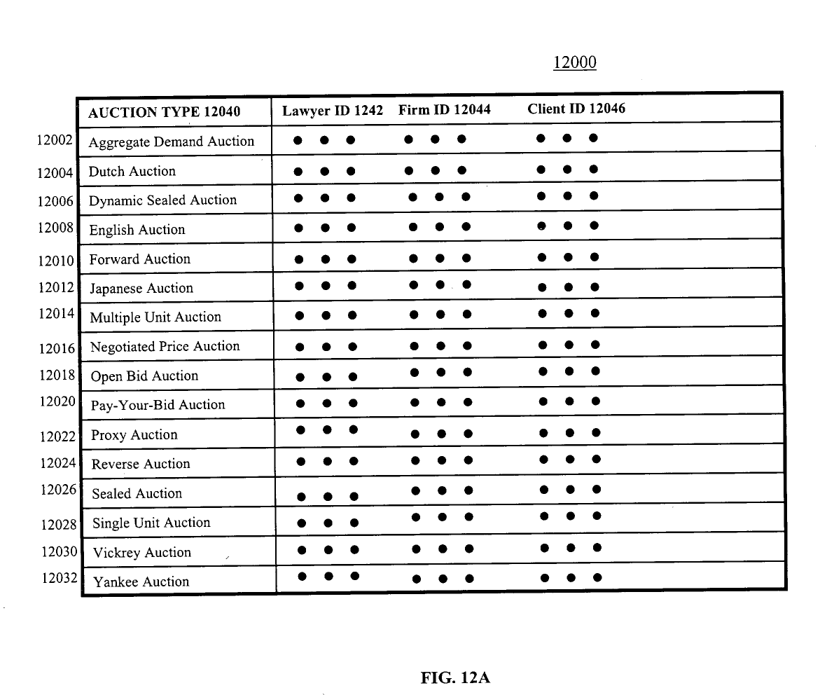

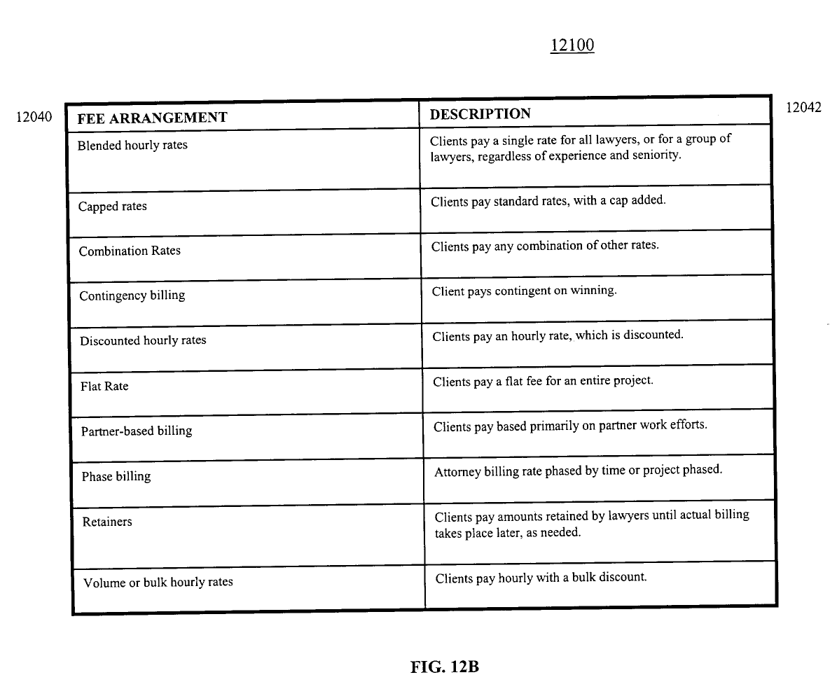

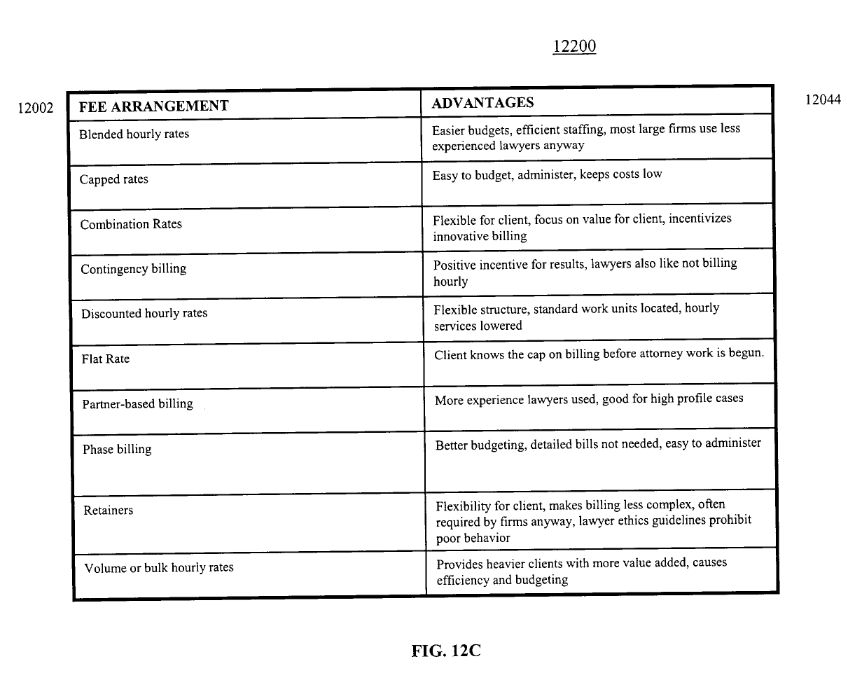

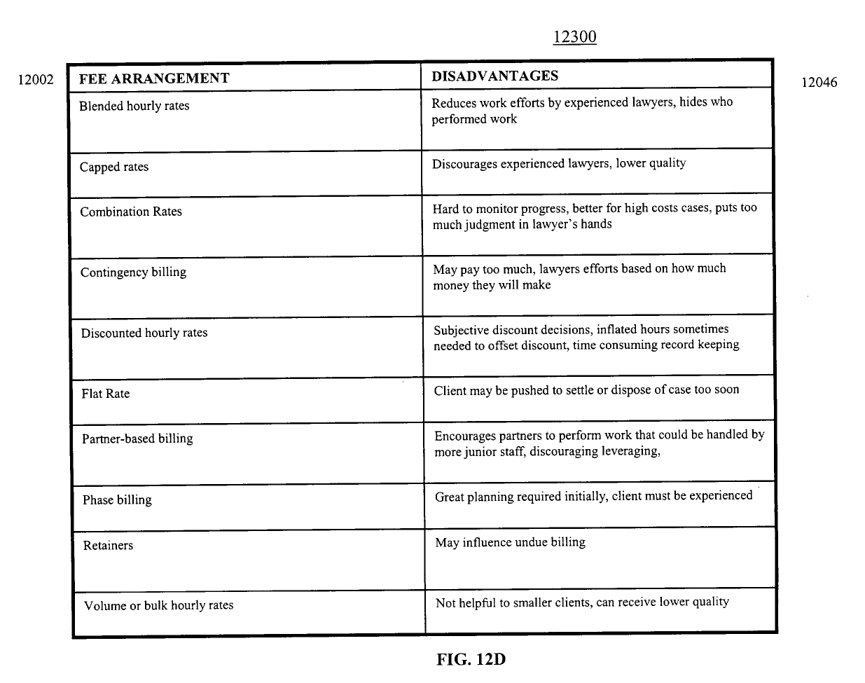

FIG. 12A illustrates a non-exhaustive list of auction types that can be used in the present invention. The auction types 12040 can be indexed, for example, based on any user entity identification information. The identification information illustrated include attorney user entity userid 12042, law firm user entity userid 12044, and client user entity userid 12046. The exemplary auction types 12040 that are shown include: aggregate demand auction 12002, Dutch auction, 12004, dynamic sealed auction 12006, English auction 12008, forward auction 12010, Japanese auction 12012, multiple unit auction 12014, negotiated price auction 12016, open bid auction 12018, pay-your-bid auctions 12020, proxy English auction 12022, reverse auction 12024, sealed auction 12026, single unit auction 12028, Vickrey auction 12030 and Yankee auction 12032. Table 4 provides descriptions of how these auction types are used in the present invention.

TABLE 4

| AUCTION | |
|---|---|
| TYPE | DESCRIPTION |
| Aggregate | First Embodiment |
| Demand | Also described as the Mercata model, this auction is performed as |
| Auction | follows. The client posts a number of legal services, and the price at |
| | which he would like the services performed. Attorneys then |
| | indicate their willingness to perform the legal work at that price. |
| | After the legal services are performed by a number of attorneys at |
| | the initial requested fee, as defined by the client beforehand, the fee |
| | drops a specified amount. Attorneys who are willing to provide |
| | services at this new, lower price now do so. When enough legal |
| | work is performed, the price will again drop. |
| | This process continues until the set legal work offering period is |
| | over. |
| | Second Embodiment |
| | This embodiment is the same in theory and action as in the first |
| | embodiment, except that (i) the clients are the bidders, bidding on |
| | the legal services of the attorneys, who post or otherwise make |
| | known their services; and (ii) the fees requested by the attorneys |
| | drop as the auction continues, similarly to how the price drops in |
| | the first embodiment. |
| Dutch Auction | First Embodiment |
| | The client posts the legal work and a price at which he/she wishes |
| | the work performed. The legal fee requested by the client is then |
| | increased until a first bid by an attorney willing to perform the legal |
| | work is accepted. The first bid is awarded the client representation. |
| | Second Embodiment |
| | This embodiment is substantially the same as the first embodiment, |
| | except that the clients are the bidders, bidding on the legal services |
| | of the attorneys, who post or otherwise make known their services. |
| | Here, the attorney decreases his/her fees until a first client makes a |
| | bid for his/her services. The first client bidder is awarded the client |
| | representation. |
| Dynamic | First and Second Embodiments |
| Sealed | These embodiment are the same as the Sealed Auction, except that |
| Auction | bidders submit bids on an item or items being offered at auction |
| | and that the other bidders are permitted to see these bids in a bid |
| | history. |
| Forward | First and Second Embodiments |
| Auction | These embodiments are variations of the other auction varieties |
| | described, where the bid prices (or beneficial conditions) for the |
| | posting party will ascend during the event. |
| Japanese | First Embodiment |
| Auction | This embodiment is the same as the English auction, with the |
| | addition that (i) once bidding starts, no new bidders are allowed to |
| | participate and (ii) when the offer amount decreases each bidder |
| | must either drop out or indicate that they are continuing to bid. |
| | Second Embodiment |
| | This embodiment is the same as the English auction, with the |
| | addition that (i) once bidding starts, no new bidders are allowed to |
| | participate and (ii) when the offer amount increases each bidder |
| | must either drop out or indicate that they are continuing to bid. |
| Multiple Unit | First Embodiment |
| Auction | This refers to when more than one item of legal work is being |
| | offered. The legal work posted need not constitute a single project |
| | or task, and can constitute multiple projects or tasks, from a single |
| | client or groups of clients for example. See Table 6. |
| | Second Embodiment |
| | This refers to when more than one item or type of legal service, by |
| | the same or multiple attorneys, is being offered. The legal work can |
| | include, for example, standard billing or alternative billing, as |
| | described herein. |
| Negotiated | First Embodiment |
| Price Auction | This dynamic commerce model, which is in actuality a typical legal |
| | contract including an offer, counter-offers, and an acceptance, is the |
| | type followed by Priceline. ™ and in the present invention. In the |
| | first embodiment, the client posts the legal work. A prospective |
| | attorney makes an offer to perform the legal work. The proposal by |
| | the client or the offer by the attorney can include details regarding |
| | the type of work, as provided in Table 6, and engagement |
| | conditions, for example. If the client accepts the attorney's offer, |
| | including the engagement conditions, for example, then there is |
| | established an attorney-client relationship and an agreement by |
| | both parties. If the client does not accept, then he or she can make |
| | a counteroffer or let the offer lapse. The process goes back and |
| | forth until a relationship is established or one party decides not the |
| | counteroffer. |
| | Second Embodiment |
| | This embodiment is the same as the first embodiment, except that |
| | the attorneys posts their services, and the clients start the offer- |
| | counter offer process, until a relationship is established or one party |
| | decides not the counteroffer. |
| Open Bid | First Embodiment |
| Auction | In this embodiment, the attorneys bidding on the legal work posted |
| | by the clients can see the bid history of other bidding attorneys. |
| | The bidding attorneys submit bids on the legal work offered at the |
| | auction within a specified amount of time. |
| | Second Embodiment |
| | In this embodiment, the clients bidding on the services posted by |
| | the attorneys can see the bid history of other bidding clients. The |
| | bidding clients submit bids on the legal services offered at the |
| | auction within a specified amount of time. |
| Pay-Your-Bid | First and Second Embodiments |
| Auctions | In the first and second embodiments, the winning bidders will be |
| | paying the amounts bid and agreeing to the conditions regarding the |
| | bid amount. The English, Sealed and Dutch are varieties of these |
| | embodiments, whereas the Vickrey is not. |
| Reverse | First and Second Embodiments |
| Auction | These embodiments are variations of the other auction varieties |
| | described, where the bid prices (or beneficial conditions) for the |
| | posting party will descend during the event. |
| Sealed | First Embodiment |
| Auction | In this embodiment, the client will post the legal work required. |
| | This is a closed version of the English auction, where the bidding |
| | attorneys will submit sealed (secret) bids. When the bidding period |
| | ends, all or substantially all of the bids for the legal work are |
| | opened. The high bidder wins and is awarded the legal work at the |
| | bid he/she offered. In a Multiple Unit variation of this |
| | embodiment, the bids are ranked from high to low, and the highest |
| | bidders win, with each performing the legal work at what he/she |
| | had bid. |
| | Second Embodiment |
| | This embodiment is the same as the first embodiment, except that |
| | the clients are the bidders, bidding on the legal services of the |
| | attorneys, who post or otherwise make known their services. |
| Single Unit | First Embodiment |
| Auction | This refers to when a single item of legal work is being offered. |
| | Examples include a single project, and a single task. See Table 6. |
| | Second Embodiment |
| | This refers to when a single item or type of legal service, by the |
| | same or multiple attorneys, is being offered. The legal work can |
| | include, for example, standard billing or alternative billing, as |
| | described herein. |
| Vickrey | First Embodiment |
| Auction | In this embodiment, the client will post the legal work required. In |
| | a multiple unit variation, the bidding attorneys with the best offers |
| | all win, but they each pay the best bid that was obtained by any |
| | single attorney. This type of auction differs from English auction, |
| | which discriminates between bidders, because the winning |
| | attorneys could get different rates. In a single unit variation, the |
| | attorney with the best bid is the winner, but he or she receives the |
| | second best bid (the highest losing bid). In one or more |
| | embodiments, the auction can be open or closed. |
| | Second Embodiment |
| | This embodiment is the same as the first embodiment, except that |
| | the clients are the bidders, bidding on the legal services of the |
| | attorneys, who post or otherwise make known their services. |
| Yankee | First Embodiment |
| Auction | This refers to when one or more identical items of legal work are |
| | being offered. The legal work posted comprises a single or |
| | multiple identical projects, for example projects, tasks, from a |
| | single client or groups of clients for example. See Table 6. |
| | Second Embodiment |
| | This refers to when one or more identical items or identical types of legal |
| | service, by the same or multiple attorneys, is being offered. The legal work |
| | can include, for example, standard billing or alternative billing, as described |
| | herein. |

In addition to and corresponding to the type of billing arrangement, the service provider user entity and the service recipient user entity can mutually agree to any know terms and conditions, including for example, how expenses are itemized and billed, and which expenses may be billed separately

In addition to the aforementioned standard billing arrangement, any type of alternative billing arrangement can be agreed to by the service provider user entities and the service recipient user entities. FIG. 12B illustrates an exemplary list of alternative billing arrangements, including the fee arrangement name 12040 and description 12042. Included in FIG. 12B are the following alternative billing fee arrangements: (i) blended hourly rates, (ii) capped rates, (iii) combination rates, (iv) contingency billing, (v) discounted hourly rates, (vi) flat rate, (vii) partner-based billing, (viii) phase billing, (ix) retainers, and (x) volume or bulk hourly rates.

FIGS. 12C and 12D respectively illustrate the advantages 12044 and disadvantages 12046 associated with the alternative billing fee arrangements, which information, among any other information, can be provided to user entities using the Law Community service system.

Any user entity can search, query, browse, any categories relating to the billing method, whether using information resident in the Law Community service system, or using external information.

I. Banking

In these embodiments, users, including the aforementioned entities are provided facilities with which to bill one another for services rendered and receive payments.

Not only can service providers, for example attorneys or law firms, receive payments using the system, but so can client user entities, third parties (or third party user entities), including the proprietors of the Law Community service system, or third parties used by the Law Community service system in rendering services.

Any of such parties can receive payments from another party on or using the Law Community Services system. Exemplary methods for charging and collecting fees on the Law Community Service system include (i) a flat fee, paid before the first usage of the Law Community Service system; (ii) a flat fee paid periodically, for example, for daily, weekly, monthly, yearly usage of the Law Community Service system; (iii) an escalating fee structure that escalates upon usage, or a de-escalating fee structure that de-escalates upon usage, whether over lifetime usage of the Law Community Service system, or periodically, for example, upon daily, weekly, monthly, yearly usage of the Law Community Service system; (iv) a transactional fee structure, where user entities who receive services (for example, legal services) are charged per transaction; (v) an advertising and/or sponsorship model structure, where advertisers and sponsors of the Law Community service system pay for being awarded the opportunity to target user entities for advertising, and either third parties, service providers, or service recipients (for example, client user entities) receive such payments; (vi) a direct marketing model, where any information gathered from user entities by the Law Community service system is sold to individuals or companies who wish to directly target such user entities for advertising, and the payment is received by third parties or user entities using the Law Community Service system; (vii) a hybrid model, which mixes one or more of the above-noted fee structures; and (viii) any other fee models recognized by skilled persons.

Any online mechanisms can be used for the aforementioned advertising and sponsorship revenue models. Table 5 includes a few exemplary revenue models, along with useful ecommerce terms. Any of these revenue models, together with any others known or anticipated by skilled persons can be used with the present invention.

TABLE 5

| ECOMMERCE | |
|---|---|
| TERMS | DESCRIPTION |
| Banner | Banner is a rectangular graphic element used for advertising on a |
| | web page, which encourages a Click-through by a user entity or other user. |
| Click-streams | Click-stream is an electronic path a user entity or other user |
| | follows during navigation between pages within a website, or |
| | between different web sites, which can be measured to determine |
| | advertising revenues. |
| Click-through | Click-Through is the clicking on an advertisement on a web page |
| | (for example, a banner ad) to link to the advertiser's web page or |
| | website. Click-through are one way to measure advertising |
| | revenues. |
| Click-Through | Click-Through Rate (CTR) is the rate of click-throughs, or |
| Rate (CTR) | advertisement response rate, usually calculated by dividing the |
| | number of click-throughs that an ad has received by the number of |
| | impressions, and multiplying by 100 to get a percentage. |
| Cost Per Action | Cost Per Action (CPA) refers to the cost to an advertiser for every |
| (CPA) | particular action, taken by user entities or other users, in response |
| | to an advertisement. The action can be a full sale, a sales lead, |
| | every time a potential customer submits certain information, the |
| | successful download of a software program, etc. |
| Cost Per Click | Cost Per Click (CPC) refers to the cost to an advertiser for every |
| (CPC) | link from an advertisement (for example, banner ad) to the |
| | advertiser's web page or website. |
| Cost Per Sale | Cost Per Sale (CPS) is the price paid by an advertiser to another |
| (CPS) | site for each sale that resulting from a visitor referred from the site |
| | to the advertiser's site. One way of tracking CPS is via cookies, |
| | applications stored on the user's computer. |
| Cost Per | Cost Per Thousand (CPM, using Roman numeral notation) refers |
| Thousand | to the cost to an advertiser for every 1,000 impressions provided to |
| (CPM) | his or her advertisement (for example, banner ad) on another site. |
| Demographics | Demographics refers to the measurement of demographic data to |
| | permit population segmentation, include by age, gender, income |
| | and location. |
| GIF | GIF is the most common compression format for banner |
| | advertisements and most others. Animated GIF is an animation |
| | created by combining multiple GIF images into one file, which is |
| | displayed to resemble movement. |
| Gross Exposures | Gross Exposures/Gross Impressions: The total number of times an |
| or Gross | ad is shown, including duplicate showings to the same person. |
| Impressions | |
| Hits | Hits refers to |
| | : Every time a file is sent by a server, be it text, graphic, video and |
| | so on, it is recorded as a hit. Not a reliable gauge to compare |
| | different sites, as one page with five graphic elements will register |
| | six hits when viewed, while a page with no graphics will only |
| | register one hit. |
| Impression | Impression refers to the Opportunity To See (OTS) of an |
| | advertisement. |
| Inventory | Inventory refers to the amount of available space for banners on a |
| | web site that can be delivered in a given time period. It is also |
| | used to refer to the number of gross impressions per month, or |
| | clicks if the CPC model is used. |
| Opportunity- | Opportunity To See (OTS) is when the user entity or other user is |
| To-See (OTS) | given the opportunity to view the impression. Although a Page- |
| | View is an OTS, an impression is not so, because the |
| | advertisement can be located at the bottom of the web page, which |
| | will not be seen unless the user scrolls down. |
| Page-View | Page-View is when a user entity or other user uses his or her |
| | browser to requests a web page, which is often used for tracking of |
| | impressions. |
| Popup Window | Pop-Up Windows are web pages that pop up between the user |
| (or Interstitial | entity or other user and what the viewer is viewing or expecting to |
| advertisement) | view. |
| Psychographics | Psychographics refers to measurement of psychological |
| | characteristics from user entities or other users to allow for |
| | segmentation of the population. Examples include retrieving |
| | information on lifestyle, purchasing behavior, attitudes. |
| Pull | Pull refers to any technology or tools that are available to the user |
| | entity or other user passively, meaning that they must visit the |
| | website and retrieve the information for themselves. |
| Push | Push refers to any technology or tools that deliver information to a |
| | user entity or other user, for example at their browser. |
| Reach | Reach is the total number of user entities or other users who will |
| | see an advertisement. |
| Sell-Through | Sell-Through Rate is the percentage of advertisements sold, not |
| Rate | bartered or traded through an advertisement network. |
| Session | Session refers to a full web site visit by a user entity or other user. |
| Sponsorship | Sponsorship is an online marketing program between a website |
| | publisher and an online advertiser designed to create the |
| | appearance that there is a close connection between the two |
| | companies. Instead of simple advertisement banner displays, a |
| | campaign can be created to blur the distinction between editorial |
| | content and promotion. In one or more embodiments, a user entity |
| | or a third party can sponsor web pages on the Law Community |
| | service system to provide advertising for themselves, and to |
| | provide fees for the proprietors of the Law Community service |
| | system, third parties, or other user entities. |
| Traffic | Traffic refers to the number (and possibly types) of user entities or |
| | users visiting the site. |

The billing information is provided to and gathered from the entity, for example at his/her browser 404, 408, and stored, maintained, uploaded, downloaded, and processed on the Law Community service system. In these embodiments, the billing features are processed and maintained by the billing method AS 526 and DS 528.

In the present invention, the manner in which bills are presented and paid can occur by any method recognized by skilled artisans. Two categories are (i) traditional bill presentment and payment and (ii) electronic bill presentment and payment (EBPP).

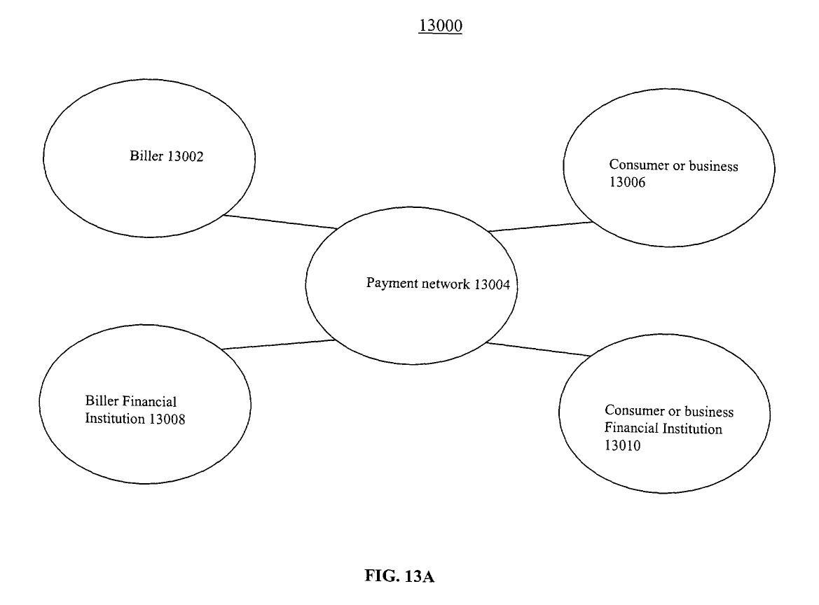

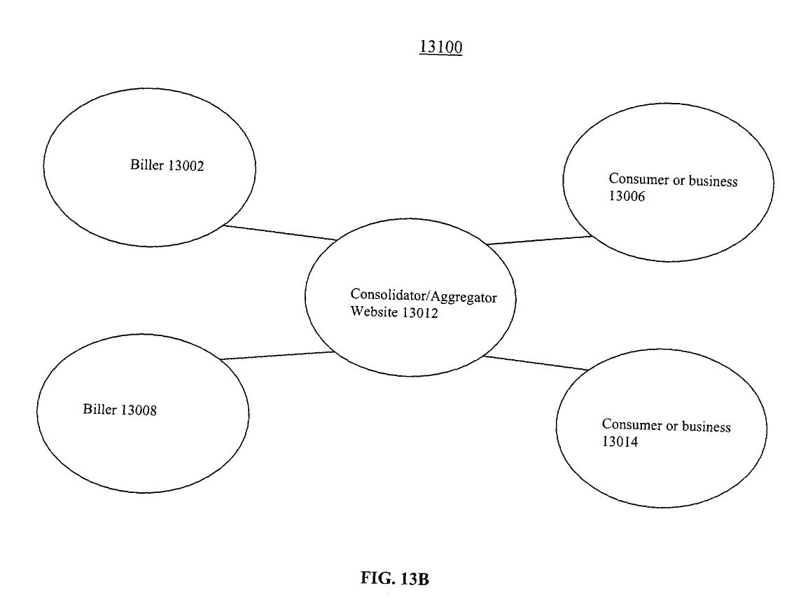

FIG. 13A illustrates an exemplary manner in which both types of bill presentment can occur. FIG. 13A includes biller 13002, consumer or business 13006, payment network 13004, biller financial institution 13008, and consumer or business financial institution 13010.

Biller 13002 is the party who bills another party for the services rendered. For example, biller 13002 can be a user entity on the Law Community service system, such as an attorney user entity, who provided services. Biller 13002 notifies consumer or business 13006 that a payment is due.

Consumer or business 13006 is the party who receives the notice that a bill is due from biller 13002. Consumer or business 13006 can be a user entity on the Law Community service system, such as a client user entity, that has received the services. In response to the notice that a bill is due, consumer or business 13006 directs that a payment be made.

When consumer or business 13006 directs a payment, the consumer or business financial institution 13010 makes a payment, through payment network 13004, to the biller financial institution 13008. In response, the biller financial institution 13008 makes the requested payment to biller 13002.

However, the model for bill payment can be much more intricate, with many more players, as skilled persons will recognize. It is possible that the consumer or business 13006 will request that payments be made through one or more intermediaries, each with their own financial institutions to make payments as directed, through the payment network 13004.

As one example, (i) a consumer or business 13006, which is a client user entity, directs that a payment be made to the Law Community service system, causing the consumer or business financial institution 13008 to make a payment to the financial institution of the Law Community service system. The Law Community service system can keep a set percentage of the payments made, and direct that a payment be made to a third party consolidator service, causing the financial institution of the Law Community service system to make a payment to the financial institution of the third party consolidator service. The third party consolidator service can then keep a set percentage of the payments made to it from the Law Community service system, and in turn direct that a payment be made to biller 13002 (for example, an attorney user entity), causing the financial institution of the third party consolidator service to make a payment to the biller financial institution 13008.

In the present invention, EBPP can occur in any known manner. Examples include a biller-direct method, a consolidation/aggregation model, and an alterative consolidation/aggregation model.

In the biller-direct method, the biller 13002 generates an electronic copy of the consumer or business billing information upon registration by the consumer or business 13006. The biller tasks can also be outsourced by the biller 13002 to a bill service provider (BSP), which provide such services as electronic bill translation, data parsing, formatting and hosting the website for the biller. Upon notification of a bill due (by such sources as e-mail), the consumer or business 13006 logs onto the website of the biller 13002 (or BSP), where the consumer or business 13006 is shown an electronic version of the billing statement, for example in a browser 408. Upon viewing the billing statement online, consumer or business 13006 makes a payment online.

In one embodiment, the consumer or business 13006 is a client user entity, and the fields shown to the client user entity or collected from him or her are any or all of the fields described above and illustrated with reference to FIGS. 6A-6E. A variety of other known login information, passwords, and security encryption algorithms can be used instead, as recognized by skilled persons.

In the consolidator/aggregation method, the biller 13002 transmits the billing information for the consumer or business 13006 to a third party consolidator/aggregation service. The third party consolidator/aggregation service will receive and combine the billing information for many billers 13002. The third party consolidator/aggregation service provide the services of electronic bill translation, data parsing, formatting and hosting on its own website, or can outsource this function to a consumer service provider (CSP), such as an Internet portal, broker website, or a financial institution.

FIG. 13B illustrates an exemplary manner in which the present invention can use a consolidation/aggregation service. FIG. 13B includes biller 13002, a second biller 13008, consumer or business 13006, a second consumer or business 13014, and a consolidation/aggregation service website 13012. Upon notification of a bill due (by such sources as e-mail), a consumer or business 13006 logs onto the consolidation/aggregation service website 13012, where the consumer or business 13006 is shown an electronic version of the billing statement, for example in a browser 408. Upon viewing the billing statement online, consumer or business 13006 makes a payment online.

In the present invention, the consolidator/aggregation method can be used with any known or anticipated standards, including Open Financial Exchange (OFX), which uses HTML, and Interactive Financial Exchange (IFX), which uses XML.

In the alternative consolidator/aggregation method, the above-noted consolidator/aggregation method is employed, with variations in the manner in which the bill is created or delivered. In one embodiment, screen scraping is used to capture information from the websites of multiple billers 13002, using user entity userids and passwords, which are then presented at another website, for example, at the screen scraper's website, or at a CSP website. In one embodiment, total bill consolidation is used, where a user entity is permitted to view and pay all of his or her bills, at a single Internet point or website. In one embodiment, consumer consolidation is used, where electronic bills are delivered to the desktop of the user entity, from which payments can be made. In one embodiment, e-mail consolidation is used, where electronic bills are delivered to a user entity via e-mail, from which payments can be made.

In the present invention, a user entity can employ any known or perceived payment mechanism and network when utilizing the EBPP process. An exemplary list of account mechanisms and networks include: Automated Clearinghouse (ACH), Electronic Fund Transfers (EFTs), Debit cards, Credit cards, Automated Teller Machines (ATMs), Automatic Transfer Service (ATS), Bankwire, Check Clearing, Clearinghouse, Clearinghouse Interbank Payments System (CHIPS), Fedwire, Federal Reserve Float, FRCS-80, Regional Check Processing Center (RCPC), and Swift.

Any user entity can search, query, browse, any categories relating to the banking method, whether using information resident in the Law Community service system, or using external information.

J. Progress Management

In these embodiments, the user entities are provided the opportunity to monitor and administer the progression of work. For example, a client user entity is provided the opportunity to monitor the status of his or her work as provided by a law firm user entity or an attorney user entity.

The monitoring of work progression can include the monitoring of any features of work performed by one user entity for another user entity. An exemplary list of these features is provided in Table 6, though skilled persons will recognize there are many other work monitoring features that can be included as well, including the numerous data collected and processed from user entities, as described above.

For example, a client user entity can receive the following information from his or her attorney user entity: (i) a description of all projects, particular projects, particular tasks within a project, particular subtasks within a task, etc.; (ii) a listing of the manner in which the client is billed for all projects, particular projects, particular tasks within a project, particular subtasks within a task, etc.; and (iii) a listing, either to-date, quarterly, or year-to-date, of the (a) billed and collected amounts, and (b) billed and uncollected amounts, for all projects, particular projects, particular tasks within a project, particular subtasks within a task, etc. Additionally, any of the foregoing features can be mutually agreed to, between the user entities. For example, the description of all projects, particular projects, particular tasks within a project, particular subtasks within a task, etc. can be mutually agreed to.

As another example, a client user entity can provide a satisfaction rating, which is a description or numerical rating regarding (i) the quality of the work product (for example, either a numerical rating or description), and (ii) the reasonableness of billing amounts, for all projects, particular projects, particular tasks within a project, particular subtasks within a task, etc. (for example, either a numerical rating or description).

In addition, any or all of the aforementioned features can be shared with other members of the Law Community service system. This can occur at various security levels, so that some individual user entities or groups of user entities can be permitted access to one or more features, whereas others are not permitted access. Examples of groups with differing security levels can include, for example, groups based on client industry areas, attorney (or firm) fields of law, geographical areas, jurisdictional areas, or user entity interests. In one embodiment, any entities or groups of entities (for example, (i) the Law Community service system, itself (with the permission of the attorneys or law firms), (ii) groups of user entities, or (iii) individual user entities) can permit access to any features on the system at any variable security levels, to the same or other groups of user entities. For example, a client user entity and an attorney user entity (performing work for the client user entity) can mutually agree to provide all other client user entities access to (i) the description of the work performed on a particular project, (ii) the amounts billed and collected from the client user entity, and (iii) the satisfaction level of the client user entity with the work of the attorney user entity.

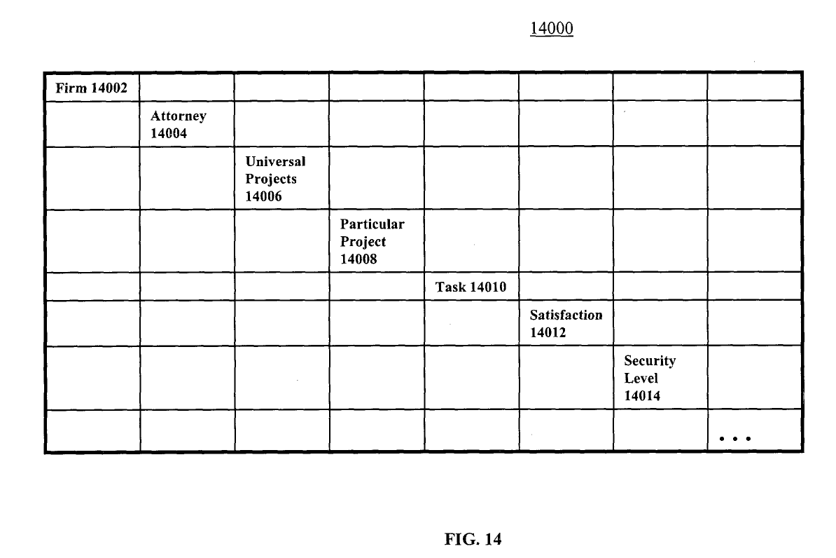

FIG. 14 is a conceptual diagram illustrating an object oriented, or multilevel view, of the progress management features described. A client user entity engages a firm user entity 14002 to perform the client's work. Within the firm user entity 14002 is an attorney user entity 14004 who accomplishes all work projects 14006 for the client. One particular project is project 14008, which includes a number of tasks, one of which is task 14010. Field 14012 is the satisfaction level for task 14010, which can be, for example, of the work quality, the amount billed, the friendliness and responsiveness of the attorney, etc., measured quantitatively or qualitatively, through a user-provided description or through predetermined means provided on the Law Community service system, each of which can be sublevels (not labeled) of the satisfaction level 14010. Lastly, one of the features associated with the satisfaction level is the security level 14014.

The features can be collected from user entities, processed, and displayed in any manner. Three exemplary manners are provided below. The first exemplary manner is through processing as already described with respect to online communication AS 522 and DS 524. For example, user entities can provide the information to one another through message threads, online chat, radio and video broadcasts.

The second exemplary manner is the processing of billing transactions as already described with respect to billing method AS 526 and DS 528, for the billing features mentioned. All of the billing methods described with references to AS 526 and DS 528 can be used to process, store and display features related to billing, and used in coordination with the features provided for progress management.

The third exemplary manner is through use of progress management AS 534 and DS 536. Progress management information is provided to and gathered from the entity, for example at his/her browser 404, and stored, maintained, uploaded, downloaded, and processed on the Law Community service system. In this third exemplary manner, work progress management is processed and maintained by the progress management AS 534 and DS 536. Accordingly, such features as provided in Table 6 and FIG. 14 are gathered from user entities, processed, and the processed information is displayed to other user entities.

TABLE 6

| ATTORNEY-CLIENT TASK | |
|---|---|
| MANAGER FIELD | DESCRIPTION |
| Client Userid | The userid of the client on the Law Community service |
| | system. |
| Attorney Userid | The userid of the attorney on the Law Community |
| | service system. |
| Firm Userid | The userid of the firm of the attorney on the Law |
| | Community service system. |
| Universal Projects Userid | A userid identifying the overall work efforts between |
| | the client and the attorney. |
| Universal Projects Description | An overall description of the work efforts between the |
| | client and the attorney. The description can be |
| | formulated by each entity individually (for example, by |
| | either the attorney or the client), or can be formulated by |
| | collaboration between them. |
| Universal Projects Updated | An updated version of the Universal Projects |
| Description | Description, which is formulated by each entity |
| | individually (for example, by either the attorney or the |
| | client), or can be formulated by collaboration between |
| | them. |
| Universal Projects Forecasted | The forecasted period of time client and/or attorney |
| Timetable | anticipated the universal projects would take to |
| | complete. |
| Universal Projects Actual | The actual period of time it is taking the attorney to |
| Timetable | complete the universal projects. A measure of how “on- |
| | track” attorney is in completing the universal projects. |
| Universal Projects Satisfaction | A quantitative or qualitative measure of the level of |
| Level | satisfaction by the client of the attorney performance for |
| | all projects. In one embodiment, other user entities of |
| | the Law Community service system are permitted access |
| | to the Universal Projects Satisfaction Level. |
| Universal Projects - Billing | The type of billing agreed to between the user entities. |
| Method | The billing methods used are described in detail with |
| | reference to billing method AS 526 and DS 528. |
| Universal Projects - Payment | The amount of forecasted payment for Universal |
| Amounts Forecasted | Projects, as agreed to by the user entities. For example, |
| | the forecasted payment agreed to by the client and the |
| | attorney, or by the client and the law firm. |
| Universal Projects - Payment | The amount of payments billed by client, and received |
| Amounts Billed and Collected | by attorney and/or the firm for Universal Projects to |
| to Date | date. |
| Universal Projects - Payment | The amount of payments billed by client, and not yet |
| Amounts Billed and | received by attorney and/or the firm for Universal |
| Uncollected to Date | Projects to date. |
| Universal Projects - Payment | The amount of payments billed by client, and received |
| Amounts Billed and Collected | by attorney and/or the firm for Universal Projects for the |
| for the Quarter or for the Year- | quarter, or year-to-date. |
| to-Date | |
| Universal Projects - Payment | The amount of payments billed by client, and not yet |
| Amounts Billed and | received by attorney and/or the firm for Universal |
| Uncollected to Date | Projects for the quarter, or year-to-date. |
| Projects Userid | A userid for a particular project, which is a |
| | subcomponent of the universal projects. |
| Projects Description | A description of a particular project. The description can |
| | be formulated by each entity individually (for example, |
| | by either the attorney or the client), or can be formulated |
| | by collaboration between them. |
| Projects Updated Description | An updated version of the Projects Description, which is |
| | formulated by each entity individually (for example, by |
| | either the attorney or the client), or can be formulated by |
| | collaboration between them. |
| Projects Forecasted Timetable | The forecasted period of time client and/or attorney |
| | anticipated the project would take to complete. |
| Projects Actual Timetable | The actual period of time it is taking the attorney to |
| | complete the project. A measure of how “on-track” |
| | attorney is in completing the project. |
| Projects Satisfaction Level | A quantitative or qualitative measure of the level of |
| | satisfaction by the client of the attorney performance for |
| | this particular project. In one embodiment, other user |
| | entities of the Law Community service system are |
| | permitted access to the Projects Satisfaction Level. |
| Projects - Billing Method | The type of billing agreed to between the user entities |
| | for this particular project. The billing methods used are |
| | described in detail with reference to billing method AS |
| | 526 and DS 528. |
| Projects - Payment Amounts | The amount of forecasted payment for this particular |
| Forecasted | project, as agreed to by the user entities. For example, |
| | the forecasted payment agreed to by the client and the |
| | attorney, or by the client and the law firm. |
| Projects - Payment Amounts | The amount of payments billed by client, and received |
| Billed and Collected to Date | by attorney and/or the firm for this particular project to |
| | date. |
| Projects - Payment Amounts | The amount of payments billed by client, and not yet |
| Billed and Uncollected to Date | received by attorney and/or the firm for this particular |
| | project to date. |
| Projects - Payment Amounts | The amount of payments billed by client, and received |
| Billed and Collected for the | by attorney and/or the firm for this particular project for |
| Quarter or for the Year-to-Date | the quarter, or year-to-date. |
| Projects - Payment Amounts | The amount of payments billed by client, and not yet |
| Billed and Uncollected to Date | received by attorney and/or the firm for this particular |
| | project for the quarter, or year-to-date. |
| Tasks Userid | A userid for a particular task, which is a subcomponent |
| | of a project. |
| Tasks Description | A description of a task. The description can be |
| | formulated by each entity individually (for example, by |
| | either the attorney or the client), or can be formulated by |
| | collaboration between them. |
| Tasks Updated Description | An updated version of the Tasks Description, which is |
| | formulated by each entity individually (for example, by |
| | either the attorney or the client), or can be formulated by |
| | collaboration between them. |
| Tasks Forecasted Timetable | The forecasted period of time client and/or attorney |
| | anticipated the task would take to complete. |
| Tasks Actual Timetable | The actual period of time it is taking the attorney to |
| | complete the task. A measure of how “on-track” |
| | attorney is in completing the task. |
| Tasks Satisfaction Level | A quantitative or qualitative measure of the level of |
| | satisfaction by the client of the attorney performance for |
| | this particular task. In one embodiment, other user |
| | entities of the Law Community service system are |
| | permitted access to the Tasks Satisfaction Level. |
| Tasks - Billing Method | The type of billing agreed to between the user entities |
| | for this particular task. The billing methods used are |
| | described in detail with reference to billing method AS |
| | 526 and DS 528. |
| Tasks - Payment Amounts | The amount of forecasted payment for this particular |
| Forecasted | task, as agreed to by the user entities. For example, the |
| | forecasted payment agreed to by the client and the |
| | attorney, or by the client and the law firm. |
| Tasks - Payment Amounts | The amount of payments billed by client, and received |
| Billed and Collected to Date | by attorney and/or the firm for this particular task to |
| | date. |
| Tasks - Payment Amounts | The amount of payments billed by client, and not yet |
| Billed and Uncollected to Date | received by attorney and/or the firm for this particular |
| | task to date. |
| Tasks - Payment Amounts | The amount of payments billed by client, and received |
| Billed and Collected for the | by attorney and/or the firm for this particular task for the |
| Quarter or sfor the Year-to- | quarter, or year-to-date. |
| Date | |
| Tasks - Payment Amounts | The amount of payments billed by client, and not yet |
| Billed and Uncollected to Date | received by attorney and/or the firm for this particular |
| | task for the quarter, or year-to-date. |

Any user entity can search, query, browse, any categories relating to the progress management method, whether using information resident in the Law Community service system, or using external information.

VIII. Conclusion

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A law community service system for providing one or more user entities using said system the ability to perform a law service related transaction, comprising:
(i) a communications network;
(ii) one or more nodes having associated processors, said nodes being interconnected via said communications network;
(iii) law service related transactions means for permitting a user entity using a first said node processor the ability to perform the law service related transaction, comprising:
(A) transmission of a law service related informational content to a second node processor from any one of: said first node processor; a third said node processor; a source external from said law community service system;
(B) processing of a said law service related informational content received by said second node processor in response to a request from said first node processor;
(C) receiving a result of said processing from said second node processor by said first node processor; and
(D) displaying said result of said processing by said first node.

2. A law community service system according to claim 1, wherein the law service related transaction means comprises one or more application servers and accompanying database servers.

3. A law community service system according to claim 1, wherein the law service related transaction relates to registration of the one or more user entities.

4. A law community service system according to claim 3, wherein the registration of the one or more user entities comprises any one of:
maintaining and updating one or more contents for a homepage;
extracting personal and professional information from the one or more user entities; and
having the one or more user entities agree to terms and conditions for using the law community service system.

5. A law community service system according to claim 1, wherein the law service related transaction relates to investigation of service provider user entities.

6. A law community service system according to claim 5, wherein the service provider user entities are attorney user entities and law firm user entities, and wherein the investigation of service provider user entities comprises:
soliciting personal information from said service provider user entities for the benefit of service recipient user entities; and
soliciting professional information from said service provider user entities for the benefit of service recipient user entities.

7. A law community service system according to claim 1, wherein the law service related transaction relates to investigation of service recipient user entities.

8. A law community service system according to claim 7, wherein the service recipient user entities are client user entities, and wherein the investigation of service recipient user entities comprises any one of:
soliciting personal information from said client user entities for the benefit of service provider user entities; and
soliciting professional information from said client user entities for the benefit of service provider user entities.

9. A law community service system according to claim 1, wherein the law service related transaction relates to client tasks.

10. A law community service system according to claim 9, wherein the client tasks comprise any one of:
soliciting criteria related to legal work from client user entities; and
providing said criteria to any one of: attorney user entities, and law firm user entities.

11. A law community service system according to claim 1, wherein the law service related transaction relates to engagement conditions.

12. A law community service system according to claim 11, wherein the client tasks comprise any one of:
online evaluation of engagement conditions between service provider user entities and service recipient user entities; and
agreement to said engagement conditions.

13. A law community service system according to claim 1, wherein the law service related transaction relates to online communication.

14. A law community service system according to claim 13, wherein the online communications comprises:
permitting user entities to communicate with one another and retrieve information online via real-time chats, video, radio and message threads.

15. A law community service system according to claim 1, wherein the law service related transaction relates to billing methods.

16. A law community service system according to claim 15, wherein the billing methods comprise any one of:
permitting the one or more user entities the ability to investigate any one of: standard billing arrangements, alternative billing arrangements, and auction billing arrangements; and
permitting any one or more of the user entities the ability to agree to terms and conditions regarding any one of said standard billing arrangements, said alternative billing arrangements, and said auction billing arrangements with any one or more of the user entities.

17. A law community service system according to claim 1, wherein the law service related transaction relates to banking.

18. A law community service system according to claim 17, wherein the banking comprises any one of:
permitting any service provider user entity the ability to be paid for services rendered to any service recipient user entity; and
permitting any party the ability to receive payments through use of the law community service system through any one of:
(i) a flat fee first usage payment structure based upon usage of the law community service system;
(ii) a flat fee structure periodic payment fee structure based upon usage of the law community service system;
(iii) an escalating fee structure based upon usage of the law community service system;
(iv) a transactional fee structure based on transactions carried through the law community service system;
(v) an advertising fee structure based upon advertisement featured on the law community service system;
(vi) a sponsorship fee structure based upon sponsorship of the law community service system;
(vii) a direct marketing fee structure whereupon user entity information is sold for payments; and
(viii) a hybrid model comprising a combination of any of (i) through (viii).

19. A law community service system according to claim 1, wherein the law service related transaction relates to progress management.

20. A law community service system according to claim 19, wherein the progress management comprises any one of:
permitting one or more client user entities to determine and manage the quality and quantity of legal work provided by one or more service provider user entities;
permitting one or more client user entities to evaluate the billing methods and payments of one or more service provider one or more user entities; and
permitting client user entities to evaluate their level of satisfaction with one or more service provider user entities.

21. A method for providing a user entity using a first node of a law community service system the ability to perform a law service related transaction, said law community service system comprising one or more nodes interconnected via a communications network, with each said node having an associated processor, the law service related transactions, comprising:
transmitting a law service related informational content to a second node processor from any one of: said first node processor; a third said node processor; a source external from said law community service system;
processing a said law service related informational content received by said second node processor in response to a request from said first node processor;
receiving a result of said processing from said second node processor by said first node processor; and
displaying said result of said processing by said first node.
